(19) United States
(12) Patent Application Publication
(10) Pub. No.: US 2025/0348512 A1
(43) Pub. Date: Nov. 13, 2025

(54) Multi-Instance Communication Support for a Computing Platform

(71) Applicant: ServiceNow, Inc., Santa Clara, CA (US)

(72) Inventors: Thunder Stumpges, Santa Clara, CA (US); Fatih Dirlikli, Santa Clara, CA (US); Yusuf Akca, Santa Clara, CA (US); Ibrahim Nasir Hussain, Santa Clara, CA (US); Raksheet Bhat, Santa Clara, CA (US)

(21) Appl. No.: 19/201,669

(22) Filed: May 7, 2025

Related U.S. Application Data
(60) Provisional application No. 63/644,060, filed on May 8, 2024.

(51) Int. Cl. G06F 16/27; G06F 21/62

(52) U.S. Cl. CPC G06F 16/273; G06F 21/6218

(57) ABSTRACT

An example embodiment may involve receiving, by a central instance, a data synchronization pull request from a computational instance, wherein the central instance stores data shared by one or more other computational instances related to the computational instance; based on the data synchronization pull request, determining portions of the data to be shared with the computational instance; validating that the computational instance is permitted access to the portions of the data; and transmitting, by the central instance and in response to the data synchronization pull request, the portions of the data to the computational instance.

### CROSS-REFERENCE TO RELATED APPLICATION

This application claims priority to U.S. patent application No. 63/644,060, filed May 8, 2024, which is hereby incorporated by reference in its entirety.

### BACKGROUND

Users of a remote network management platform often employ more than one logically distinct computational instance thereof. For example, different computational instances may be used for production, testing, and development. Each computational instance may include one or more computing nodes, database nodes, and/or other components that facilitate providing database tables, application logic, a web-based interface, and/or other modules for application use and development. However, users are currently unable to easily view the computing resources (e.g., processors, memory, software installations, and/or application data) allocated to or used by each of their computational instances. This results in wasted computing resources due to out of date allocations, as well as wasted computing resources due to users having to remotely access each computational instance separately to query its computing resource allocation.

### SUMMARY

Various implementations disclosed herein include a multi-instance framework (MIF) that provides users with visibility of their computing resource allocations across some or all of their computational instances. A MIF can be composed of two scoped applications (herein referred to as MIF central and MIF client) facilitating the flow of data between computational instances and a central instance. Applications using the MIF framework may be configured to determine what data to collect, while the MIF framework oversees the transfer of data while honoring predetermined trust settings that specify the computational instances with which to share the data.

Communication between central and computational instances may be initiated by a computational instance via scheduled jobs. MIF can use mutual transport layer security (mTLS) and public key infrastructure (PKI) authentication and authorization features potentially based on certificates. For example, these may include sub-identity assertion, which allows for declarative assertions against additional attributes that are added in a PKI sub-identity header, providing further details from where in each computational instance a request originates.

MIF allows for automatic discovery of computational instances belonging to the same user or group of users, while also allowing a default trust configuration that determines which of their computational instances have access to what other MIF-onboarded data. MIF can use protocols based on representational state transfer (REST) for communication, though other types of protocols (e.g., a message broker atop Apache Kafka) could be used.

A system of one or more computers can be configured to perform particular operations or actions by virtue of having software, firmware, hardware, or a combination thereof installed on the system that in operation causes or cause the system to perform the actions. One or more computer programs can be configured to perform particular operations or actions by virtue of including instructions that, when executed by data processing apparatus, cause the apparatus to perform the actions.

One general aspect involves a method. The method includes receiving, by a central instance, a data synchronization pull request from a computational instance, where the central instance stores data shared by one or more other computational instances related to the computational instance. The method also includes based on the data synchronization pull request, determining portions of the data to be shared with the computational instance. The method also includes validating that the computational instance is permitted access to the portions of the data. The method also includes transmitting, by the central instance and in response to the data synchronization pull request, the portions of the data to the computational instance. Other embodiments of this aspect include corresponding computer systems, apparatus, and computer programs recorded on one or more computer storage devices, each configured to perform the actions of the method.

Another general aspect also involves a method. The method includes transmitting, by a computational instance, a data synchronization pull request to a central instance, where the data synchronization pull request is for portions of data shared by one or more other computational instances related to the computational instance. The method also includes receiving, by the computational instance and from the central instance, the portions of the data. The method also includes identifying, from the portions of the data, database tables on the computational instance in which the portions of the data are to be stored. The method also includes updating the database tables to include the portions of the data. Other embodiments of this aspect include corresponding computer systems, apparatus, and computer programs recorded on one or more computer storage devices, each configured to perform the actions of the method.

These, as well as other embodiments, aspects, advantages, and alternatives, will become apparent to those of ordinary skill in the art by reading the following detailed description, with reference where appropriate to the accompanying drawings. Further, this summary and other descriptions and figures provided herein are intended to illustrate embodiments by way of example only and, as such, that numerous variations are possible. For instance, structural elements and process steps can be rearranged, combined, distributed, eliminated, or otherwise changed, while remaining within the scope of the embodiments as claimed.

### BRIEF DESCRIPTION OF THE DRAWINGS

FIG. 1 illustrates a schematic drawing of a computing device, in accordance with example embodiments.

FIG. 2 illustrates a schematic drawing of a server device cluster, in accordance with example embodiments.

FIG. 3 depicts a remote network management architecture, in accordance with example embodiments.

FIG. 4 depicts a communication environment involving a remote network management architecture, in accordance with example embodiments.

FIG. 5 depicts another communication environment involving a remote network management architecture, in accordance with example embodiments.

FIGS. 6A and 6B depict an architecture of a multi-instance framework, in accordance with example embodiments.

FIGS. 7A and 7B depict database schemas for a multi-instance framework, in accordance with example embodiments.

FIG. 8A depicts communication between instances, in accordance with example embodiments.

FIG. 8B depicts configuration pull communication, in accordance with example embodiments.

FIG. 8C depicts configuration push communication, in accordance with example embodiments.

FIG. 8D depicts data pull communication, in accordance with example embodiments.

FIG. 8E depicts data push communication, in accordance with example embodiments.

FIG. 9 depicts a security procedure, in accordance with example embodiments.

FIG. 10 provides a security policy, in accordance with example embodiments.

FIG. 11 depicts a registration/discovery process for computational instances, in accordance with example embodiments.

FIG. 12 depicts central instance tables for data synchronization, in accordance with example embodiments.

FIG. 13 depicts a cloning configuration for computational instances, in accordance with example embodiments.

FIG. 14 depicts the timing of synchronization processes, in accordance with example embodiments.

FIG. 15 depicts a user interface displaying synchronization status, in accordance with example embodiments.

FIG. 16 is a flow chart, in accordance with example embodiments.

FIG. 17 is a flow chart, in accordance with example embodiments.

### DETAILED DESCRIPTION

Example methods, devices, and systems are described herein. It should be understood that the words “example” and “exemplary” are used herein to mean “serving as an example, instance, or illustration.” Any embodiment or feature described herein as being an “example” or “exemplary” is not necessarily to be construed as preferred or advantageous over other embodiments or features unless stated as such. Thus, other embodiments can be utilized and other changes can be made without departing from the scope of the subject matter presented herein.

Accordingly, the example embodiments described herein are not meant to be limiting. It will be readily understood that the aspects of the present disclosure, as generally described herein, and illustrated in the figures, can be arranged, substituted, combined, separated, and designed in a wide variety of different configurations. For example, the separation of features into “client” and “server” components may occur in a number of ways.

Further, unless context suggests otherwise, the features illustrated in each of the figures may be used in combination with one another. Thus, the figures should be generally viewed as component aspects of one or more overall embodiments, with the understanding that not all illustrated features are necessary for each embodiment.

Additionally, any enumeration of elements, blocks, or steps in this specification or the claims is for purposes of clarity. Thus, such enumeration should not be interpreted to require or imply that these elements, blocks, or steps adhere to a particular arrangement or are carried out in a particular order.

Unless clearly indicated otherwise herein, the term “or” is to be interpreted as the inclusive disjunction. For example, the phrase “A, B, or C” is true if any one or more of the arguments A, B, C are true, and is only false if all of A, B, and C are false.

### I. EXAMPLE TECHNICAL IMPROVEMENTS

These embodiments provide a technical solution to a technical problem. One technical problem being solved is sharing data between computational instances. In practice, this is problematic because many users employ multiple computational instances at a given time, some in use as production environments and others in use as non-production environments.

Users of these computational instances are currently unable to easily view the computing resources (e.g., processors, memory, software installations, and/or application data) allocated to or used by each of their computational instances, much less data related to applications operable on the computational instances. This results in wasted computing resources due to—among other things—users having to remotely access and log into each computational instance separately to query its respective computing resource allocation and application status. Unnecessary or redundant logins, even when they succeed and do not result in visible errors, incur non-trivial overhead across various layers of a computational instance. Every time a user performs such a login, a computational instance expends processing cycles to carry out cryptographic authentication (e.g. TLS negotiation, password hashing, or token validation), allocate and populate session objects in memory, initiate audit logs, and render a user interface. In real-world scenarios, such during as debugging procedures, users may wind up performing these unnecessary logins several times per hour.

The embodiments herein overcome these limitations by enabling data sharing to occur automatically and in the background across multiple computational instances. This reduces login overhead, as users can view data from any computational instance by logging into just one of them. In this manner, at least compute and memory capacity is reduced. To that point, the low-overheard communication between instances, e.g., based on a REST interface, facilitates this data transfer without complexity of supporting a full login procedure.

Other technical improvements may also flow from these embodiments, and other technical problems may be solved. Thus, this statement of technical improvements is not limiting and instead constitutes examples of advantages that can be realized from the embodiments.

### II. INTRODUCTION

A large enterprise is a complex entity with many interrelated operations. Some of these are found across the enterprise, such as human resources (HR), supply chain, information technology (IT), and finance. However, each enterprise also has its own unique operations that provide essential capabilities and/or create competitive advantages.

To support widely-implemented operations, enterprises typically use off-the-shelf software applications, such as customer relationship management (CRM), IT service management (ITSM), IT operations management (ITOM), and human capital management (HCM) packages. However, they may also need custom software applications to meet their own unique requirements. A large enterprise often has dozens or hundreds of these custom software applications. Nonetheless, the advantages provided by the embodiments herein are not limited to large enterprises and may be applicable to an enterprise, or any other type of organization, of any size.

Many such software applications are developed by individual departments within the enterprise. These range from simple spreadsheets to custom-built software tools and databases. But the proliferation of siloed custom software applications has numerous disadvantages. It negatively impacts an enterprise's ability to run and grow its operations, innovate, and meet regulatory requirements. The enterprise may find it difficult to integrate, streamline, and enhance its operations due to lack of a single system that unifies its subsystems and data.

To efficiently create custom applications, enterprises would benefit from a remotely-hosted application platform that eliminates unnecessary development complexity. The goal of such a platform would be to reduce time-consuming, repetitive application development tasks so that software engineers and individuals in other roles can focus on developing unique, high-value features.

In order to achieve this goal, the concept of Application Platform as a Service (aPaaS) has been introduced to intelligently automate workflows throughout the enterprise. An aPaaS system is hosted remotely from the enterprise, but may access data, applications, and services within the enterprise by way of secure connections. Such an aPaaS system may have a number of advantageous capabilities and characteristics. These advantages and characteristics may be able to improve the enterprise's operations and workflows for IT, HR, CRM, customer service, application development, and security. Nonetheless, the embodiments herein are not limited to enterprise applications or environments, and can be more broadly applied.

The aPaaS system may support development and execution of model-view-controller (MVC) applications. MVC applications divide their functionality into three interconnected parts (model, view, and controller) in order to isolate representations of information from the manner in which the information is presented to the user, thereby allowing for efficient code reuse and parallel development. These applications may be web-based, and offer create, read, update, and delete (CRUD) capabilities. This allows new applications to be built on a common application infrastructure. In some cases, applications structured differently than MVC, such as those using unidirectional data flow, may be employed.

The aPaaS system may support standardized application components, such as a standardized set of widgets and/or web components for graphical user interface (GUI) development. In this way, applications built using the aPaaS system have a common look and feel. Other software components and modules may be standardized as well. In some cases, this look and feel can be branded or skinned with an enterprise's custom logos and/or color schemes.

The aPaaS system may support the ability to configure the behavior of applications using metadata. This allows application behaviors to be rapidly adapted to meet specific needs. Such an approach reduces development time and increases flexibility. Further, the aPaaS system may support GUI tools that facilitate metadata creation and management, thus reducing errors in the metadata.

The aPaaS system may support clearly-defined interfaces between applications, so that software developers can avoid unwanted inter-application dependencies. Thus, the aPaaS system may implement a service layer in which persistent state information and other data are stored.

The aPaaS system may support a rich set of integration features so that the applications thereon can interact with legacy applications and third-party applications. For instance, the aPaaS system may support a custom employee-onboarding system that integrates with legacy HR, IT, and accounting systems.

The aPaaS system may support enterprise-grade security. Furthermore, since the aPaaS system may be remotely hosted, it should also utilize security procedures when it interacts with systems in the enterprise or third-party networks and services hosted outside of the enterprise. For example, the aPaaS system may be configured to share data amongst the enterprise and other parties to detect and identify common security threats.

Other features, functionality, and advantages of an aPaaS system may exist. This description is for purpose of example and is not intended to be limiting.

As an example of the aPaaS development process, a software developer may be tasked to create a new application using the aPaaS system. First, the developer may define the data model, which specifies the types of data that the application uses and the relationships therebetween. Then, via a GUI of the aPaaS system, the developer enters (e.g., uploads) the data model. The aPaaS system automatically creates all of the corresponding database tables, fields, and relationships, which can then be accessed via an object-oriented services layer.

In addition, the aPaaS system can also build a fully-functional application with client-side interfaces and server-side CRUD logic. This generated application may serve as the basis of further development for the user. Advantageously, the developer does not have to spend a large amount of time on basic application functionality. Further, since the application may be web-based, it can be accessed from any Internet-enabled client device. Alternatively or additionally, a local copy of the application may be able to be accessed, for instance, when Internet service is not available.

The aPaaS system may also support a rich set of pre-defined functionality that can be added to applications. These features include support for searching, email, templating, workflow design, reporting, analytics, social media, scripting, mobile-friendly output, and customized GUIs.

Such an aPaaS system may represent a GUI in various ways. For example, a server device of the aPaaS system may generate a representation of a GUI using a combination of HyperText Markup Language (HTML) and JAVASCRIPT®. The JAVASCRIPT® may include client-side executable code, server-side executable code, or both. The server device may transmit or otherwise provide this representation to a client device for the client device to display on a screen according to its locally-defined look and feel. Alternatively, a representation of a GUI may take other forms, such as an intermediate form (e.g., JAVA® byte-code) that a client device can use to directly generate graphical output therefrom. Other possibilities exist, including but not limited to metadata-based encodings of web components, and various uses of JAVASCRIPT® Object Notation (JSON) and/or extensible Markup Language (XML) to represent various aspects of a GUI.

Further, user interaction with GUI elements, such as buttons, menus, tabs, sliders, checkboxes, toggles, etc. may be referred to as “selection”, “activation”, or “actuation” thereof. These terms may be used regardless of whether the GUI elements are interacted with by way of keyboard, pointing device, touchscreen, or another mechanism.

An aPaaS architecture is particularly powerful when integrated with an enterprise's network and used to manage such a network. The following embodiments describe architectural and functional aspects of example aPaaS systems, as well as the features and advantages thereof.

### III. EXAMPLE COMPUTING DEVICES AND CLOUD-BASED COMPUTING ENVIRONMENTS

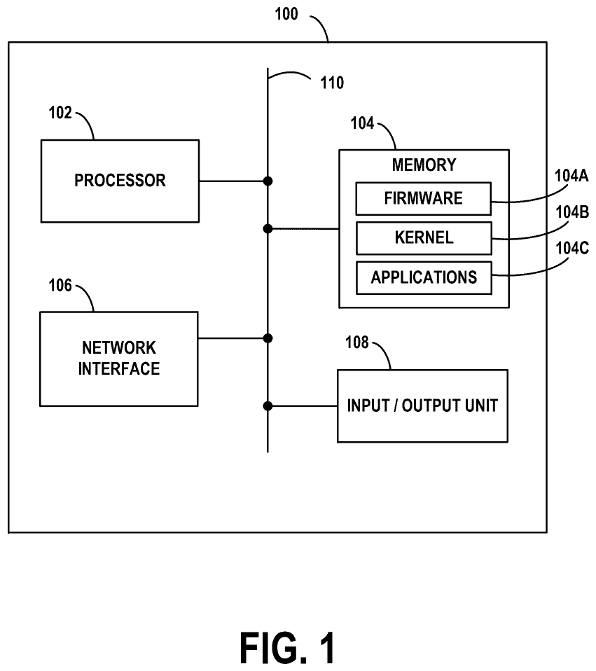

FIG. 1 is a simplified block diagram exemplifying a computing device 100, illustrating some of the components that could be included in a computing device arranged to operate in accordance with the embodiments herein. Computing device 100 could be a client device (e.g., a device actively operated by a user), a server device (e.g., a device that provides computational services to client devices), or some other type of computational platform. Some server devices may operate as client devices from time to time in order to perform particular operations, and some client devices may incorporate server features.

In this example, computing device 100 includes processor 102, memory 104, network interface 106, and input/output unit 108, all of which may be coupled by system bus 110 or a similar mechanism. In some embodiments, computing device 100 may include other components and/or peripheral devices (e.g., detachable storage, printers, and so on).

Processor 102 may be one or more of any type of computer processing element, such as a central processing unit (CPU), a graphical processing unit (GPU), another form of co-processor (e.g., a mathematics or encryption co-processor), a digital signal processor (DSP), a network processor, and/or a form of integrated circuit or controller that performs processor operations. In some cases, processor 102 may be one or more single-core processors. In other cases, processor 102 may be one or more multi-core processors with multiple independent processing units. Processor 102 may also include register memory for temporarily storing instructions being executed and related data, as well as cache memory for temporarily storing recently-used instructions and data.

Memory 104 may be any form of computer-usable memory, including but not limited to random access memory (RAM), read-only memory (ROM), and non-volatile memory (e.g., flash memory, hard disk drives, solid state drives, compact discs (CDs), digital video discs (DVDs), and/or tape storage). Thus, memory 104 represents both main memory units, as well as long-term storage.

Memory 104 may store program instructions and/or data on which program instructions may operate. By way of example, memory 104 may store these program instructions on a non-transitory, computer-readable medium, such that the instructions are executable by processor 102 to carry out any of the methods, processes, or operations disclosed in this specification or the accompanying drawings.

As shown in FIG. 1, memory 104 may include firmware 104A, kernel 104B, and/or applications 104C. Firmware 104A may be program code used to boot or otherwise initiate some or all of computing device 100. Kernel 104B may be an operating system, including modules for memory management, scheduling and management of processes, input/output, and communication. Kernel 104B may also include device drivers that allow the operating system to communicate with the hardware modules (e.g., memory units, networking interfaces, ports, and buses) of computing device 100. Applications 104C may be one or more user-space software programs, such as web browsers or email clients, as well as any software libraries used by these programs. Memory 104 may also store data used by these and other programs and applications.

Network interface 106 may take the form of one or more wireline interfaces, such as Ethernet (e.g., Fast Ethernet, Gigabit Ethernet, 10 Gigabit Ethernet, Ethernet over fiber, and so on). Network interface 106 may also support communication over one or more non-Ethernet media, such as coaxial cables or power lines, or over wide-area media, such as Synchronous Optical Networking (SONET), Data Over Cable Service Interface Specification (DOCSIS), or digital subscriber line (DSL) technologies. Network interface 106 may additionally take the form of one or more wireless interfaces, such as IEEE 802.11 (Wifi), BLUETOOTH®, global positioning system (GPS), or a wide-area wireless interface. However, other forms of physical layer interfaces and other types of standard or proprietary communication protocols may be used over network interface 106. Furthermore, network interface 106 may comprise multiple physical interfaces. For instance, some embodiments of computing device 100 may include Ethernet, BLUETOOTH®, and Wifi interfaces.

Input/output unit 108 may facilitate user and peripheral device interaction with computing device 100. Input/output unit 108 may include one or more types of input devices, such as a keyboard, a mouse, a touch screen, and so on. Similarly, input/output unit 108 may include one or more types of output devices, such as a screen, monitor, printer, and/or one or more light emitting diodes (LEDs). Additionally or alternatively, computing device 100 may communicate with other devices using a universal serial bus (USB) or high-definition multimedia interface (HDMI) port interface, for example.

In some embodiments, one or more computing devices like computing device 100 may be deployed. The exact physical location, connectivity, and configuration of these computing devices may be unknown and/or unimportant to client devices. Accordingly, the computing devices may be referred to as “cloud-based” devices that may be housed at various remote data center locations.

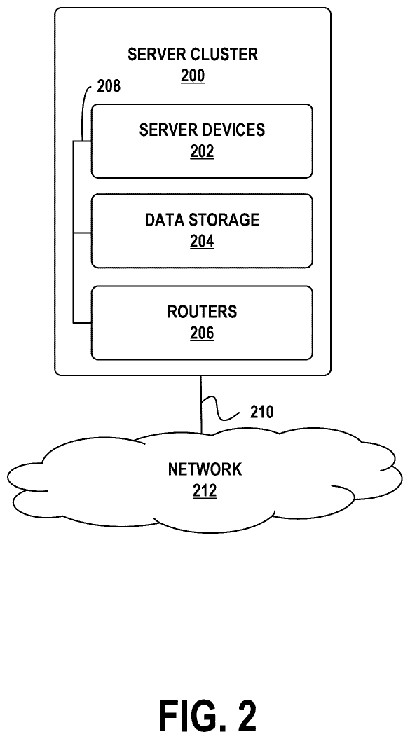

FIG. 2 depicts a cloud-based server cluster 200 in accordance with example embodiments. In FIG. 2, operations of a computing device (e.g., computing device 100) may be distributed between server devices 202, data storage 204, and routers 206, all of which may be connected by local cluster network 208. The number of server devices 202, data storages 204, and routers 206 in server cluster 200 may depend on the computing task(s) and/or applications assigned to server cluster 200.

For example, server devices 202 can be configured to perform various computing tasks of computing device 100. Thus, computing tasks can be distributed among one or more of server devices 202. To the extent that these computing tasks can be performed in parallel, such a distribution of tasks may reduce the total time to complete these tasks and return a result. For purposes of simplicity, both server cluster 200 and individual server devices 202 may be referred to as a “server device.” This nomenclature should be understood to imply that one or more distinct server devices, data storage devices, and cluster routers may be involved in server device operations.

Data storage 204 may be data storage arrays that include drive array controllers configured to manage read and write access to groups of hard disk drives and/or solid state drives. The drive array controllers, alone or in conjunction with server devices 202, may also be configured to manage backup or redundant copies of the data stored in data storage 204 to protect against drive failures or other types of failures that prevent one or more of server devices 202 from accessing units of data storage 204. Other types of memory aside from drives may be used.

Routers 206 may include networking equipment configured to provide internal and external communications for server cluster 200. For example, routers 206 may include one or more packet-switching and/or routing devices (including switches and/or gateways) configured to provide (i) network communications between server devices 202 and data storage 204 via local cluster network 208, and/or (ii) network communications between server cluster 200 and other devices via communication link 210 to network 212.

Additionally, the configuration of routers 206 can be based at least in part on the data communication requirements of server devices 202 and data storage 204, the latency and throughput of the local cluster network 208, the latency, throughput, and cost of communication link 210, and/or other factors that may contribute to the cost, speed, fault-tolerance, resiliency, efficiency, and/or other design goals of the system architecture.

As a possible example, data storage 204 may include any form of database, such as a structured query language (SQL) database or a No-SQL database (e.g., MongoDB). Various types of data structures may store the information in such a database, including but not limited to files, tables, arrays, lists, trees, and tuples. Furthermore, any databases in data storage 204 may be monolithic or distributed across multiple physical devices.

Server devices 202 may be configured to transmit data to and receive data from data storage 204. This transmission and retrieval may take the form of SQL queries or other types of database queries, and the output of such queries, respectively. Additional text, images, video, and/or audio may be included as well. Furthermore, server devices 202 may organize the received data into web page or web application representations. Such a representation may take the form of a markup language, such as HTML, XML, JSON, or some other standardized or proprietary format. Moreover, server devices 202 may have the capability of executing various types of computerized scripting languages, such as but not limited to Perl, Python, PHP Hypertext Preprocessor (PHP), Active Server Pages (ASP), JAVASCRIPT®, and so on. Computer program code written in these languages may facilitate the providing of web pages to client devices, as well as client device interaction with the web pages. Alternatively or additionally, JAVA® may be used to facilitate generation of web pages and/or to provide web application functionality.

### IV. EXAMPLE REMOTE NETWORK MANAGEMENT ARCHITECTURE

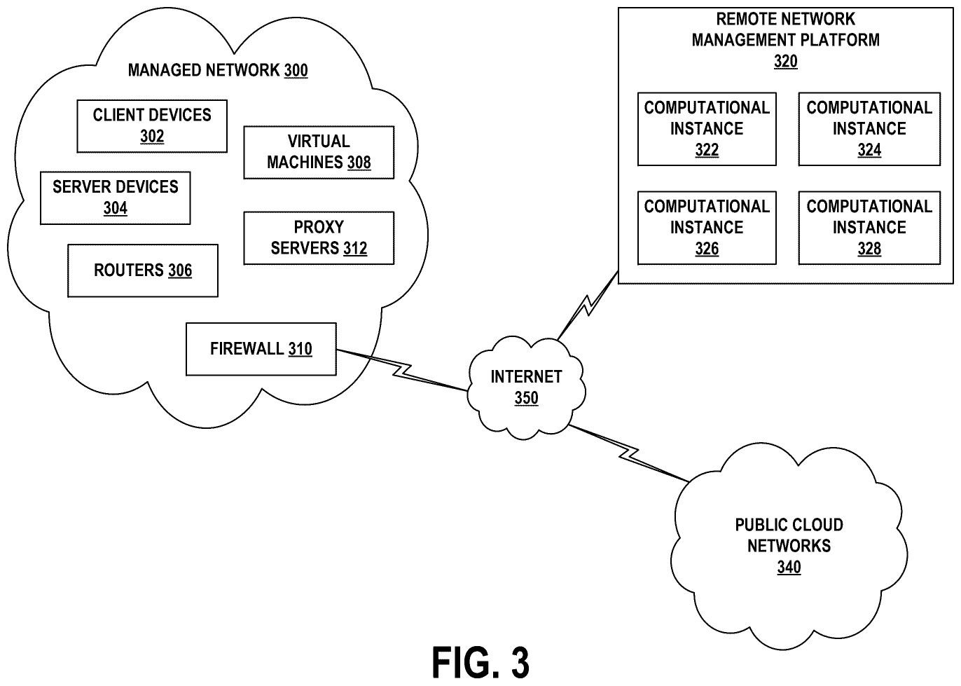

FIG. 3 depicts a remote network management architecture, in accordance with example embodiments. This architecture includes three main components—managed network 300, remote network management platform 320, and public cloud networks 340—all connected by way of Internet 350.

### A. Managed Networks

Managed network 300 may be, for example, an enterprise network used by an entity for computing and communications tasks, as well as storage of data. Thus, managed network 300 may include client devices 302, server devices 304, routers 306, virtual machines 308, firewall 310, and/or proxy servers 312. Client devices 302 may be embodied by computing device 100, server devices 304 may be embodied by computing device 100 or server cluster 200, and routers 306 may be any type of router, switch, or gateway.

Virtual machines 308 may be embodied by one or more of computing device 100 or server cluster 200. In general, a virtual machine is an emulation of a computing system, and mimics the functionality (e.g., processor, memory, and communication resources) of a physical computer. One physical computing system, such as server cluster 200, may support up to thousands of individual virtual machines. In some embodiments, virtual machines 308 may be managed by a centralized server device or application that facilitates allocation of physical computing resources to individual virtual machines, as well as performance and error reporting. Enterprises often employ virtual machines in order to allocate computing resources in an efficient, as needed fashion. Providers of virtualized computing systems include VMWARE® and MICROSOFT®.

Firewall 310 may be one or more specialized routers or server devices that protect managed network 300 from unauthorized attempts to access the devices, applications, and services therein, while allowing authorized communication that is initiated from managed network 300. Firewall 310 may also provide intrusion detection, web filtering, virus scanning, application-layer gateways, and other applications or services. In some embodiments not shown in FIG. 3, managed network 300 may include one or more virtual private network (VPN) gateways with which it communicates with remote network management platform 320 (see below).

Managed network 300 may also include one or more proxy servers 312. An embodiment of proxy servers 312 may be a server application that facilitates communication and movement of data between managed network 300, remote network management platform 320, and public cloud networks 340. In particular, proxy servers 312 may be able to establish and maintain secure communication sessions with one or more computational instances of remote network management platform 320. By way of such a session, remote network management platform 320 may be able to discover and manage aspects of the architecture and configuration of managed network 300 and its components.

Possibly with the assistance of proxy servers 312, remote network management platform 320 may also be able to discover and manage aspects of public cloud networks 340 that are used by managed network 300. While not shown in FIG. 3, one or more proxy servers 312 may be placed in any of public cloud networks 340 in order to facilitate this discovery and management.

Firewalls, such as firewall 310, typically deny all communication sessions that are incoming by way of Internet 350, unless such a session was ultimately initiated from behind the firewall (i.e., from a device on managed network 300) or the firewall has been explicitly configured to support the session. By placing proxy servers 312 behind firewall 310 (e.g., within managed network 300 and protected by firewall 310), proxy servers 312 may be able to initiate these communication sessions through firewall 310. Thus, firewall 310 might not have to be specifically configured to support incoming sessions from remote network management platform 320, thereby avoiding potential security risks to managed network 300.

In some cases, managed network 300 may consist of a few devices and a small number of networks. In other deployments, managed network 300 may span multiple physical locations and include hundreds of networks and hundreds of thousands of devices. Thus, the architecture depicted in FIG. 3 is capable of scaling up or down by orders of magnitude.

Furthermore, depending on the size, architecture, and connectivity of managed network 300, a varying number of proxy servers 312 may be deployed therein. For example, each one of proxy servers 312 may be responsible for communicating with remote network management platform 320 regarding a portion of managed network 300. Alternatively or additionally, sets of two or more proxy servers may be assigned to such a portion of managed network 300 for purposes of load balancing, redundancy, and/or high availability.

### B. Remote Network Management Platforms

Remote network management platform 320 is a hosted environment that provides aPaaS services to users, particularly to the operator of managed network 300. These services may take the form of web-based portals, for example, using the aforementioned web-based technologies. Thus, a user can securely access remote network management platform 320 from, for example, client devices 302, or potentially from a client device outside of managed network 300. By way of the web-based portals, users may design, test, and deploy applications, generate reports, view analytics, and perform other tasks. Remote network management platform 320 may also be referred to as a multi-application platform.

As shown in FIG. 3, remote network management platform 320 includes four computational instances 322, 324, 326, and 328. Each of these computational instances may represent one or more server nodes operating dedicated copies of the aPaaS software and/or one or more database nodes. The arrangement of server and database nodes on physical server devices and/or virtual machines can be flexible and may vary based on enterprise needs. In combination, these nodes may provide a set of web portals, services, and applications (e.g., a wholly-functioning aPaaS system) available to a particular enterprise. In some cases, a single enterprise may use multiple computational instances.

For example, managed network 300 may be an enterprise customer of remote network management platform 320, and may use computational instances 322, 324, and 326. The reason for providing multiple computational instances to one customer is that the customer may wish to independently develop, test, and deploy its applications and services. Thus, computational instance 322 may be dedicated to application development related to managed network 300, computational instance 324 may be dedicated to testing these applications, and computational instance 326 may be dedicated to the live operation of tested applications and services. A computational instance may also be referred to as a hosted instance, a remote instance, a customer instance, or by some other designation. Any application deployed onto a computational instance may be a scoped application, in that its access to databases within the computational instance can be restricted to certain elements therein (e.g., one or more particular database tables or particular rows within one or more database tables).

For purposes of clarity, the disclosure herein refers to the arrangement of application nodes, database nodes, aPaaS software executing thereon, and underlying hardware as a “computational instance.” Note that users may colloquially refer to the graphical user interfaces provided thereby as “instances.” But unless it is defined otherwise herein, a “computational instance” is a computing system disposed within remote network management platform 320.

The multi-instance architecture of remote network management platform 320 is in contrast to conventional multi-tenant architectures, over which multi-instance architectures exhibit several advantages. In multi-tenant architectures, data from different customers (e.g., enterprises) are comingled in a single database. While these customers' data are separate from one another, the separation is enforced by the software that operates the single database. As a consequence, a security breach in this system may affect all customers' data, creating additional risk, especially for entities subject to governmental, healthcare, and/or financial regulation. Furthermore, any database operations that affect one customer will likely affect all customers sharing that database. Thus, if there is an outage due to hardware or software errors, this outage affects all such customers. Likewise, if the database is to be upgraded to meet the needs of one customer, it will be unavailable to all customers during the upgrade process. Often, such maintenance windows will be long, due to the size of the shared database.

In contrast, the multi-instance architecture provides each customer with its own database in a dedicated computing instance. This prevents comingling of customer data, and allows each instance to be independently managed. For example, when one customer's instance experiences an outage due to errors or an upgrade, other computational instances are not impacted. Maintenance down time is limited because the database only contains one customer's data. Further, the simpler design of the multi-instance architecture allows redundant copies of each customer database and instance to be deployed in a geographically diverse fashion. This facilitates high availability, where the live version of the customer's instance can be moved when faults are detected or maintenance is being performed.

In some embodiments, remote network management platform 320 may include one or more central instances, controlled by the entity that operates this platform. Like a computational instance, a central instance may include some number of application and database nodes disposed upon some number of physical server devices or virtual machines. Such a central instance may serve as a repository for specific configurations of computational instances as well as data that can be shared amongst at least some of the computational instances. For instance, definitions of common security threats that could occur on the computational instances, software packages that are commonly discovered on the computational instances, and/or an application store for applications that can be deployed to the computational instances may reside in a central instance. Computational instances may communicate with central instances by way of well-defined interfaces in order to obtain this data.

In order to support multiple computational instances in an efficient fashion, remote network management platform 320 may implement a plurality of these instances on a single hardware platform. For example, when the aPaaS system is implemented on a server cluster such as server cluster 200, it may operate virtual machines that dedicate varying amounts of computational, storage, and communication resources to instances. But full virtualization of server cluster 200 might not be necessary, and other mechanisms may be used to separate instances. In some examples, each instance may have a dedicated account and one or more dedicated databases on server cluster 200. Alternatively, a computational instance such as computational instance 322 may span multiple physical devices.

In some cases, a single server cluster of remote network management platform 320 may support multiple independent enterprises. Furthermore, as described below, remote network management platform 320 may include multiple server clusters deployed in geographically diverse data centers in order to facilitate load balancing, redundancy, and/or high availability.

### C. Public Cloud Networks

Public cloud networks 340 may be remote server devices (e.g., a plurality of server clusters such as server cluster 200) that can be used for outsourced computation, data storage, communication, and service hosting operations. These servers may be virtualized (i.e., the servers may be virtual machines). Examples of public cloud networks 340 may include Amazon AWS Cloud, Microsoft Azure Cloud (Azure), Google Cloud Platform (GCP), and IBM Cloud Platform. Like remote network management platform 320, multiple server clusters supporting public cloud networks 340 may be deployed at geographically diverse locations for purposes of load balancing, redundancy, and/or high availability.

Managed network 300 may use one or more of public cloud networks 340 to deploy applications and services to its clients and customers. For instance, if managed network 300 provides online music streaming services, public cloud networks 340 may store the music files and provide web interface and streaming capabilities. In this way, the enterprise of managed network 300 does not have to build and maintain its own servers for these operations.

Remote network management platform 320 may include modules that integrate with public cloud networks 340 to expose virtual machines and managed services therein to managed network 300. The modules may allow users to request virtual resources, discover allocated resources, and provide flexible reporting for public cloud networks 340. In order to establish this functionality, a user from managed network 300 might first establish an account with public cloud networks 340, and request a set of associated resources. Then, the user may enter the account information into the appropriate modules of remote network management platform 320. These modules may then automatically discover the manageable resources in the account, and also provide reports related to usage, performance, and billing.

### D. Communication Support and Other Operations

Internet 350 may represent a portion of the global Internet. However, Internet 350 may alternatively represent a different type of network, such as a private wide-area or local-area packet-switched network.

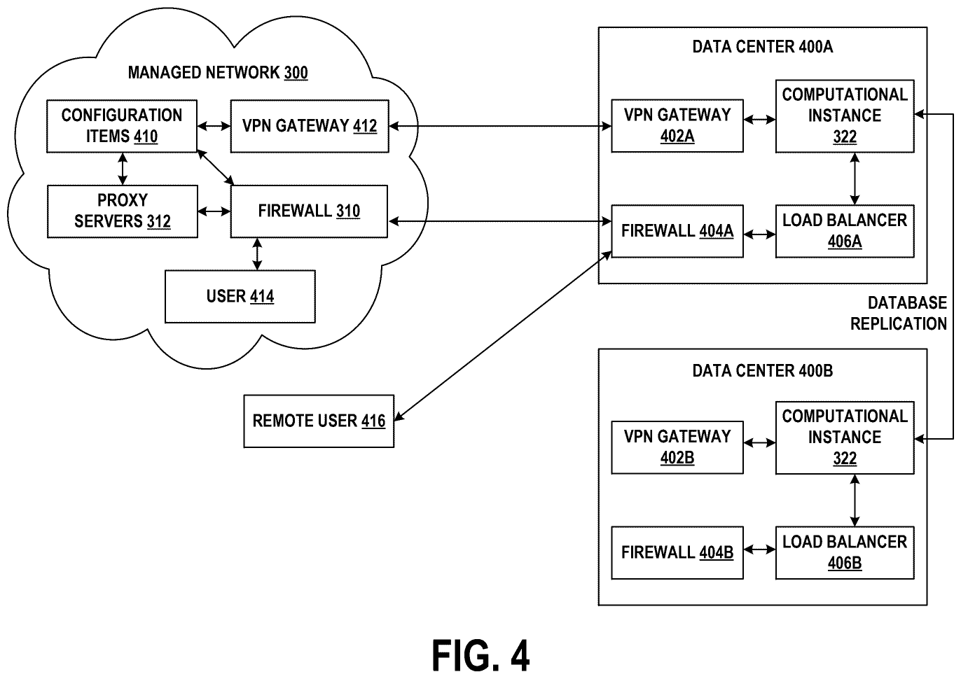

FIG. 4 further illustrates the communication environment between managed network 300 and computational instance 322, and introduces additional features and alternative embodiments. In FIG. 4, computational instance 322 is replicated, in whole or in part, across data centers 400A and 400B. These data centers may be geographically distant from one another, perhaps in different cities or different countries. Each data center includes support equipment that facilitates communication with managed network 300, as well as remote users.

In data center 400A, network traffic to and from external devices flows either through VPN gateway 402A or firewall 404A. VPN gateway 402A may be peered with VPN gateway 412 of managed network 300 by way of a security protocol such as Internet Protocol Security (IPSEC) or Transport Layer Security (TLS). Firewall 404A may be configured to allow access from authorized users, such as user 414 and remote user 416, and to deny access to unauthorized users. By way of firewall 404A, these users may access computational instance 322, and possibly other computational instances. Load balancer 406A may be used to distribute traffic amongst one or more physical or virtual server devices that host computational instance 322. Load balancer 406A may simplify user access by hiding the internal configuration of data center 400A, (e.g., computational instance 322) from client devices. For instance, if computational instance 322 includes multiple physical or virtual computing devices that share access to multiple databases, load balancer 406A may distribute network traffic and processing tasks across these computing devices and databases so that no one computing device or database is significantly busier than the others. In some embodiments, computational instance 322 may include VPN gateway 402A, firewall 404A, and load balancer 406A.

Data center 400B may include its own versions of the components in data center 400A. Thus, VPN gateway 402B, firewall 404B, and load balancer 406B may perform the same or similar operations as VPN gateway 402A, firewall 404A, and load balancer 406A, respectively. Further, by way of real-time or near-real-time database replication and/or other operations, computational instance 322 may exist simultaneously in data centers 400A and 400B.

Data centers 400A and 400B as shown in FIG. 4 may facilitate redundancy and high availability. In the configuration of FIG. 4, data center 400A is active and data center 400B is passive. Thus, data center 400A is serving all traffic to and from managed network 300, while the version of computational instance 322 in data center 400B is being updated in near-real-time. Other configurations, such as one in which both data centers are active, may be supported.

Should data center 400A fail in some fashion or otherwise become unavailable to users, data center 400B can take over as the active data center. For example, domain name system (DNS) servers that associate a domain name of computational instance 322 with one or more Internet Protocol (IP) addresses of data center 400A may re-associate the domain name with one or more IP addresses of data center 400B. After this re-association completes (which may take less than one second or several seconds), users may access computational instance 322 by way of data center 400B.

FIG. 4 also illustrates a possible configuration of managed network 300. As noted above, proxy servers 312 and user 414 may access computational instance 322 through firewall 310. Proxy servers 312 may also access configuration items 410. In FIG. 4, configuration items 410 may refer to any or all of client devices 302, server devices 304, routers 306, and virtual machines 308, any components thereof, any applications or services executing thereon, as well as relationships between devices, components, applications, and services. Thus, the term “configuration items” may be shorthand for part of all of any physical or virtual device, or any application or service remotely discoverable or managed by computational instance 322, or relationships between discovered devices, applications, and services. Configuration items may be represented in a configuration management database (CMDB) of computational instance 322.

As stored or transmitted, a configuration item may be a list of attributes that characterize the hardware or software that the configuration item represents. These attributes may include manufacturer, vendor, location, owner, unique identifier, description, network address, operational status, serial number, time of last update, and so on. The class of a configuration item may determine which subset of attributes are present for the configuration item (e.g., software and hardware configuration items may have different lists of attributes).

As noted above, VPN gateway 412 may provide a dedicated VPN to VPN gateway 402A. Such a VPN may be helpful when there is a significant amount of traffic between managed network 300 and computational instance 322, or security policies otherwise suggest or require use of a VPN between these sites. In some embodiments, any device in managed network 300 and/or computational instance 322 that directly communicates via the VPN is assigned a public IP address. Other devices in managed network 300 and/or computational instance 322 may be assigned private IP addresses (e.g., IP addresses selected from the 10.0.0.0-10.255.255.255 or 192.168.0.0-192.168.255.255 ranges, represented in shorthand as subnets 10.0.0.0/8 and 192.168.0.0/16, respectively). In various alternatives, devices in managed network 300, such as proxy servers 312, may use a secure protocol (e.g., TLS) to communicate directly with one or more data centers.

### V. EXAMPLE DISCOVERY

In order for remote network management platform 320 to administer the devices, applications, and services of managed network 300, remote network management platform 320 may first determine what devices are present in managed network 300, the configurations, constituent components, and operational statuses of these devices, and the applications and services provided by the devices. Remote network management platform 320 may also determine the relationships between discovered devices, their components, applications, and services. Representations of these devices, components, applications, and services may be referred to as configuration items.

The process of determining the configuration items and relationships therebetween within managed network 300 is referred to as discovery, and may be facilitated at least in part by proxy servers 312. To that point, proxy servers 312 may relay discovery requests and responses between managed network 300 and remote network management platform 320.

Configuration items and relationships may be stored in a CMDB and/or other locations. Further, configuration items may be of various classes that define their constituent attributes and that exhibit an inheritance structure not unlike object-oriented software modules. For instance, a configuration item class of “server” may inherit all attributes from a configuration item class of “hardware” and also include further server-specific attributes. Likewise, a configuration item class of “LINUX® server” may inherit all attributes from the configuration item class of “server” and also include further LINUX®-specific attributes. Additionally, configuration items may represent other components, such as services, data center infrastructure, software licenses, units of source code, configuration files, and documents.

While this section describes discovery conducted on managed network 300, the same or similar discovery procedures may be used on public cloud networks 340. Thus, in some environments, “discovery” may refer to discovering configuration items and relationships on a managed network and/or one or more public cloud networks.

For purposes of the embodiments herein, an “application” may refer to one or more processes, threads, programs, client software modules, server software modules, or any other software that executes on a device or group of devices. A “service” may refer to a high-level capability provided by one or more applications executing on one or more devices working in conjunction with one another. For example, a web service may involve multiple web application server threads executing on one device and accessing information from a database application that executes on another device.

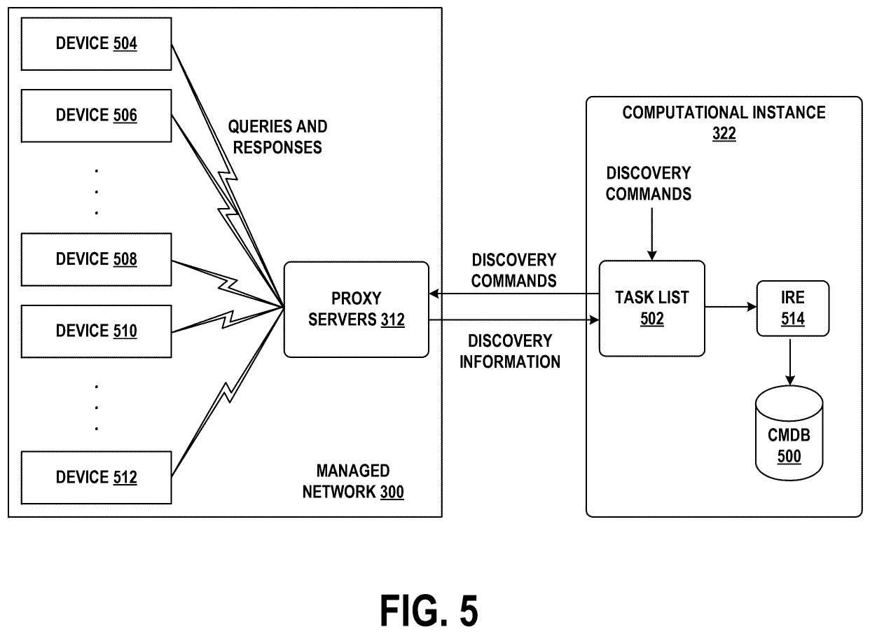

FIG. 5 provides a logical depiction of how configuration items and relationships can be discovered, as well as how information related thereto can be stored. For sake of simplicity, remote network management platform 320, public cloud networks 340, and Internet 350 are not shown.

In FIG. 5, CMDB 500, task list 502, and identification and reconciliation engine (IRE) 514 are disposed and/or operate within computational instance 322. Task list 502 represents a connection point between computational instance 322 and proxy servers 312. Task list 502 may be referred to as a queue, or more particularly as an external communication channel (ECC) queue. Task list 502 may represent not only the queue itself but any associated processing, such as adding, removing, and/or manipulating information in the queue.

As discovery takes place, computational instance 322 may store discovery tasks (jobs) that proxy servers 312 are to perform in task list 502, until proxy servers 312 request these tasks in batches of one or more. Placing the tasks in task list 502 may trigger or otherwise cause proxy servers 312 to begin their discovery operations. For example, proxy servers 312 may poll task list 502 periodically or from time to time, or may be notified of discovery commands in task list 502 in some other fashion. Alternatively or additionally, discovery may be manually triggered or automatically triggered based on triggering events (e.g., discovery may automatically begin once per day at a particular time).

Regardless, computational instance 322 may transmit these discovery commands to proxy servers 312 upon request. For example, proxy servers 312 may repeatedly query task list 502, obtain the next task therein, and perform this task until task list 502 is empty or another stopping condition has been reached. In response to receiving a discovery command, proxy servers 312 may query various devices, components, applications, and/or services in managed network 300 (represented for sake of simplicity in FIG. 5 by devices 504, 506, 508, 510, and 512). These devices, components, applications, and/or services may provide responses relating to their configuration, operation, and/or status to proxy servers 312. In turn, proxy servers 312 may then provide this discovered information to task list 502 (i.e., task list 502 may have an outgoing queue for holding discovery commands until requested by proxy servers 312 as well as an incoming queue for holding the discovery information until it is read).

IRE 514 may be a software module that removes discovery information from task list 502 and formulates this discovery information into configuration items (e.g., representing devices, components, applications, and/or services discovered on managed network 300) as well as relationships therebetween. Then, IRE 514 may provide these configuration items and relationships to CMDB 500 for storage therein. The operation of IRE 514 is described in more detail below.

In this fashion, configuration items stored in CMDB 500 represent the environment of managed network 300. As an example, these configuration items may represent a set of physical and/or virtual devices (e.g., client devices, server devices, routers, or virtual machines), applications executing thereon (e.g., web servers, email servers, databases, or storage arrays), as well as services that involve multiple individual configuration items. Relationships may be pairwise definitions of arrangements or dependencies between configuration items.

In order for discovery to take place in the manner described above, proxy servers 312, CMDB 500, and/or one or more credential stores may be configured with credentials for the devices to be discovered. Credentials may include any type of information needed in order to access the devices. These may include userid/password pairs, certificates, and so on. In some embodiments, these credentials may be stored in encrypted fields of CMDB 500. Proxy servers 312 may contain the decryption key for the credentials so that proxy servers 312 can use these credentials to log on to or otherwise access devices being discovered.

There are two general types of discovery-horizontal and vertical (top-down). Each are discussed below.

### A. Horizontal Discovery

Horizontal discovery is used to scan managed network 300, find devices, components, and/or applications, and then populate CMDB 500 with configuration items representing these devices, components, and/or applications. Horizontal discovery also creates relationships between the configuration items. For instance, this could be a “runs on” relationship between a configuration item representing a software application and a configuration item representing a server device on which it executes. Typically, horizontal discovery is not aware of services and does not create relationships between configuration items based on the services in which they operate.

There are two versions of horizontal discovery. One relies on probes and sensors, while the other also employs patterns. Probes and sensors may be scripts (e.g., written in JAVASCRIPT®) that collect and process discovery information on a device and then update CMDB 500 accordingly. More specifically, probes explore or investigate devices on managed network 300, and sensors parse the discovery information returned from the probes.

Patterns are also scripts that collect data on one or more devices, process it, and update the CMDB. Patterns differ from probes and sensors in that they are written in a specific discovery programming language and are used to conduct detailed discovery procedures on specific devices, components, and/or applications that often cannot be reliably discovered (or discovered at all) by more general probes and sensors. Particularly, patterns may specify a series of operations that define how to discover a particular arrangement of devices, components, and/or applications, what credentials to use, and which CMDB tables to populate with configuration items resulting from this discovery.

Both versions may proceed in four logical phases: scanning, classification, identification, and exploration. Also, both versions may require specification of one or more ranges of IP addresses on managed network 300 for which discovery is to take place. Each phase may involve communication between devices on managed network 300 and proxy servers 312, as well as between proxy servers 312 and task list 502. Some phases may involve storing partial or preliminary configuration items in CMDB 500, which may be updated in a later phase.

In the scanning phase, proxy servers 312 may probe each IP address in the specified range(s) of IP addresses for open Transmission Control Protocol (TCP) and/or User Datagram Protocol (UDP) ports to determine the general type of device and its operating system. The presence of such open ports at an IP address may indicate that a particular application is operating on the device that is assigned the IP address, which in turn may identify the operating system used by the device. For example, if TCP port 135 is open, then the device is likely executing a WINDOWS® operating system. Similarly, if TCP port 22 is open, then the device is likely executing a UNIX® operating system, such as LINUX®. If UDP port 161 is open, then the device may be able to be further identified through the Simple Network Management Protocol (SNMP). Other possibilities exist.

In the classification phase, proxy servers 312 may further probe each discovered device to determine the type of its operating system. The probes used for a particular device are based on information gathered about the devices during the scanning phase. For example, if a device is found with TCP port 22 open, a set of UNIX®-specific probes may be used. Likewise, if a device is found with TCP port 135 open, a set of WINDOWS®-specific probes may be used. For either case, an appropriate set of tasks may be placed in task list 502 for proxy servers 312 to carry out. These tasks may result in proxy servers 312 logging on, or otherwise accessing information from the particular device. For instance, if TCP port 22 is open, proxy servers 312 may be instructed to initiate a Secure Shell (SSH) connection to the particular device and obtain information about the specific type of operating system thereon from particular locations in the file system. Based on this information, the operating system may be determined. As an example, a UNIX® device with TCP port 22 open may be classified as AIX®, HPUX, LINUX®, MACOS®, or SOLARIS®. This classification information may be stored as one or more configuration items in CMDB 500.

In the identification phase, proxy servers 312 may determine specific details about a classified device. The probes used during this phase may be based on information gathered about the particular devices during the classification phase. For example, if a device was classified as LINUX®, a set of LINUX®-specific probes may be used. Likewise, if a device was classified as WINDOWS® 10, as a set of WINDOWS®-10-specific probes may be used. As was the case for the classification phase, an appropriate set of tasks may be placed in task list 502 for proxy servers 312 to carry out. These tasks may result in proxy servers 312 reading information from the particular device, such as basic input/output system (BIOS) information, serial numbers, network interface information, media access control address(es) assigned to these network interface(s), IP address(es) used by the particular device and so on. This identification information may be stored as one or more configuration items in CMDB 500 along with any relevant relationships therebetween. Doing so may involve passing the identification information through IRE 514 to avoid generation of duplicate configuration items, for purposes of disambiguation, and/or to determine the table(s) of CMDB 500 in which the discovery information should be written.

In the exploration phase, proxy servers 312 may determine further details about the operational state of a classified device. The probes used during this phase may be based on information gathered about the particular devices during the classification phase and/or the identification phase. Again, an appropriate set of tasks may be placed in task list 502 for proxy servers 312 to carry out. These tasks may result in proxy servers 312 reading additional information from the particular device, such as processor information, memory information, lists of running processes (software applications), and so on. Once more, the discovered information may be stored as one or more configuration items in CMDB 500, as well as relationships.

Running horizontal discovery on certain devices, such as switches and routers, may utilize SNMP. Instead of or in addition to determining a list of running processes or other application-related information, discovery may determine additional subnets known to a router and the operational state of the router's network interfaces (e.g., active, inactive, queue length, number of packets dropped, etc.). The IP addresses of the additional subnets may be candidates for further discovery procedures. Thus, horizontal discovery may progress iteratively or recursively.

Patterns are used only during the identification and exploration phases-under pattern-based discovery, the scanning and classification phases operate as they would if probes and sensors are used. After the classification stage completes, a pattern probe is specified as a probe to use during identification. Then, the pattern probe and the pattern that it specifies are launched.

Patterns support a number of features, by way of the discovery programming language, that are not available or difficult to achieve with discovery using probes and sensors. For example, discovery of devices, components, and/or applications in public cloud networks, as well as configuration file tracking, is much simpler to achieve using pattern-based discovery. Further, these patterns are more easily customized by users than probes and sensors. Additionally, patterns are more focused on specific devices, components, and/or applications and therefore may execute faster than the more general approaches used by probes and sensors.

Once horizontal discovery completes, a configuration item representation of each discovered device, component, and/or application is available in CMDB 500. For example, after discovery, operating system version, hardware configuration, and network configuration details for client devices, server devices, and routers in managed network 300, as well as applications executing thereon, may be stored as configuration items. This collected information may be presented to a user in various ways to allow the user to view the hardware composition and operational status of devices.

Furthermore, CMDB 500 may include entries regarding the relationships between configuration items. More specifically, suppose that a server device includes a number of hardware components (e.g., processors, memory, network interfaces, storage, and file systems), and has several software applications installed or executing thereon. Relationships between the components and the server device (e.g., “contained by” relationships) and relationships between the software applications and the server device (e.g., “runs on” relationships) may be represented as such in CMDB 500.

More generally, the relationship between a software configuration item installed or executing on a hardware configuration item may take various forms, such as “is hosted on”, “runs on”, or “depends on”. Thus, a database application installed on a server device may have the relationship “is hosted on” with the server device to indicate that the database application is hosted on the server device. In some embodiments, the server device may have a reciprocal relationship of “used by” with the database application to indicate that the server device is used by the database application. These relationships may be automatically found using the discovery procedures described above, though it is possible to manually set relationships as well.

In this manner, remote network management platform 320 may discover and inventory the hardware and software deployed on and provided by managed network 300.

### B. Vertical Discovery

Vertical discovery is a technique used to find and map configuration items that are part of an overall service, such as a web service. For example, vertical discovery can map a web service by showing the relationships between a web server application, a LINUX® server device, and a database that stores the data for the web service. Typically, horizontal discovery is run first to find configuration items and basic relationships therebetween, and then vertical discovery is run to establish the relationships between configuration items that make up a service.

Patterns can be used to discover certain types of services, as these patterns can be programmed to look for specific arrangements of hardware and software that fit a description of how the service is deployed. Alternatively or additionally, traffic analysis (e.g., examining network traffic between devices) can be used to facilitate vertical discovery. In some cases, the parameters of a service can be manually configured to assist vertical discovery.

In general, vertical discovery seeks to find specific types of relationships between devices, components, and/or applications. Some of these relationships may be inferred from configuration files. For example, the configuration file of a web server application can refer to the IP address and port number of a database on which it relies. Vertical discovery patterns can be programmed to look for such references and infer relationships therefrom. Relationships can also be inferred from traffic between devices—for instance, if there is a large extent of web traffic (e.g., TCP port 80 or 8080) traveling between a load balancer and a device hosting a web server, then the load balancer and the web server may have a relationship.

Relationships found by vertical discovery may take various forms. As an example, an email service may include an email server software configuration item and a database application software configuration item, each installed on different hardware device configuration items. The email service may have a “depends on” relationship with both of these software configuration items, while the software configuration items have a “used by” reciprocal relationship with the email service. Such services might not be able to be fully determined by horizontal discovery procedures, and instead may rely on vertical discovery and possibly some extent of manual configuration.

### C. Advantages of Discovery

Regardless of how discovery information is obtained, it can be valuable for the operation of a managed network. Notably, IT personnel can quickly determine where certain software applications are deployed, and what configuration items make up a service. This allows for rapid pinpointing of root causes of service outages or degradation. For example, if two different services are suffering from slow response times, the CMDB can be queried (perhaps among other activities) to determine that the root cause is a database application that is used by both services having high processor utilization. Thus, IT personnel can address the database application rather than waste time considering the health and performance of other configuration items that make up the services.

In another example, suppose that a database application is executing on a server device, and that this database application is used by an employee onboarding service as well as a payroll service. Thus, if the server device is taken out of operation for maintenance, it is clear that the employee onboarding service and payroll service will be impacted. Likewise, the dependencies and relationships between configuration items may be able to represent the services impacted when a particular hardware device fails.

In general, configuration items and/or relationships between configuration items may be displayed on a web-based interface and represented in a hierarchical fashion. Modifications to such configuration items and/or relationships in the CMDB may be accomplished by way of this interface.

Furthermore, users from managed network 300 may develop workflows that allow certain coordinated activities to take place across multiple discovered devices. For instance, an IT workflow might allow the user to change the common administrator password to all discovered LINUX® devices in a single operation.

### VI. CMDB IDENTIFICATION RULES AND RECONCILIATION

A CMDB, such as CMDB 500, provides a repository of configuration items and relationships. When properly provisioned, it can take on a key role in higher-layer applications deployed within or involving a computational instance. These applications may relate to enterprise IT service management, operations management, asset management, configuration management, compliance, and so on.

For example, an IT service management application may use information in the CMDB to determine applications and services that may be impacted by a component (e.g., a server device) that has malfunctioned, crashed, or is heavily loaded. Likewise, an asset management application may use information in the CMDB to determine which hardware and/or software components are being used to support particular enterprise applications. As a consequence of the importance of the CMDB, it is desirable for the information stored therein to be accurate, consistent, and up to date.

A CMDB may be populated in various ways. As discussed above, a discovery procedure may automatically store information including configuration items and relationships in the CMDB. However, a CMDB can also be populated, as a whole or in part, by manual entry, configuration files, and third-party data sources. Given that multiple data sources may be able to update the CMDB at any time, it is possible that one data source may overwrite entries of another data source. Also, two data sources may each create slightly different entries for the same configuration item, resulting in a CMDB containing duplicate data. When either of these occurrences takes place, they can cause the health and utility of the CMDB to be reduced.

In order to mitigate this situation, these data sources might not write configuration items directly to the CMDB. Instead, they may write to an identification and reconciliation application programming interface (API) of IRE 514. Then, IRE 514 may use a set of configurable identification rules to uniquely identify configuration items and determine whether and how they are to be written to the CMDB.

In general, an identification rule specifies a set of configuration item attributes that can be used for this unique identification. Identification rules may also have priorities so that rules with higher priorities are considered before rules with lower priorities. Additionally, a rule may be independent, in that the rule identifies configuration items independently of other configuration items. Alternatively, the rule may be dependent, in that the rule first uses a metadata rule to identify a dependent configuration item.

Metadata rules describe which other configuration items are contained within a particular configuration item, or the host on which a particular configuration item is deployed. For example, a network directory service configuration item may contain a domain controller configuration item, while a web server application configuration item may be hosted on a server device configuration item.

A goal of each identification rule is to use a combination of attributes that can unambiguously distinguish a configuration item from all other configuration items, and is expected not to change during the lifetime of the configuration item. Some possible attributes for an example server device may include serial number, location, operating system, operating system version, memory capacity, and so on. If a rule specifies attributes that do not uniquely identify the configuration item, then multiple components may be represented as the same configuration item in the CMDB. Also, if a rule specifies attributes that change for a particular configuration item, duplicate configuration items may be created.

Thus, when a data source provides information regarding a configuration item to IRE 514, IRE 514 may attempt to match the information with one or more rules. If a match is found, the configuration item is written to the CMDB or updated if it already exists within the CMDB. If a match is not found, the configuration item may be held for further analysis.

Configuration item reconciliation procedures may be used to ensure that only authoritative data sources are allowed to overwrite configuration item data in the CMDB. This reconciliation may also be rules-based. For instance, a reconciliation rule may specify that a particular data source is authoritative for a particular configuration item type and set of attributes. Then, IRE 514 might only permit this authoritative data source to write to the particular configuration item, and writes from unauthorized data sources may be prevented. Thus, the authorized data source becomes the single source of truth regarding the particular configuration item. In some cases, an unauthorized data source may be allowed to write to a configuration item if it is creating the configuration item or the attributes to which it is writing are empty.

Additionally, multiple data sources may be authoritative for the same configuration item or attributes thereof. To avoid ambiguities, these data sources may be assigned precedences that are taken into account during the writing of configuration items. For example, a secondary authorized data source may be able to write to a configuration item's attribute until a primary authorized data source writes to this attribute. Afterward, further writes to the attribute by the secondary authorized data source may be prevented.

In some cases, duplicate configuration items may be automatically detected by IRE 514 or in another fashion. These configuration items may be deleted or flagged for manual de-duplication.

### VII. MULTI-INSTANCE FRAMEWORK

Various implementations disclosed herein include a multi-instance framework (MIF) that provides users with visibility of their computing resource allocations across some or all of their computational instances. MIF allows for automatic discovery of computational instances belonging to the same user or group of users, while also allowing a default trust configuration that determines which of their computational instances see what other MIF-supported data.

As an example, a user may maintain two computational instances, one for production and another for test. The test computational instance may include a database table, rows of which are shared (e.g., synchronized) by way of MIF with a central instance. Thus, the central instance may store a copy of at least a portion of the database table. The central instance may also share (e.g., synchronize) its copy of the database table with the production computational instance. Therefore, by way of one or more user interfaces on the production computational instance, the user may be able to view the content of the database table without having to log on to the test computational instance.

The data shared from the test computational instance to the production computational instance need not overwrite any corresponding data or database tables in the production computational instance. Instead, the production computational instance is able to process and provide views of the shared data without impacting any data it stores locally.

As illustrated below, MIF can support the synchronizing of data between more than just two computational instances. Also, the shared data need not be in the form of a database table or even a database.

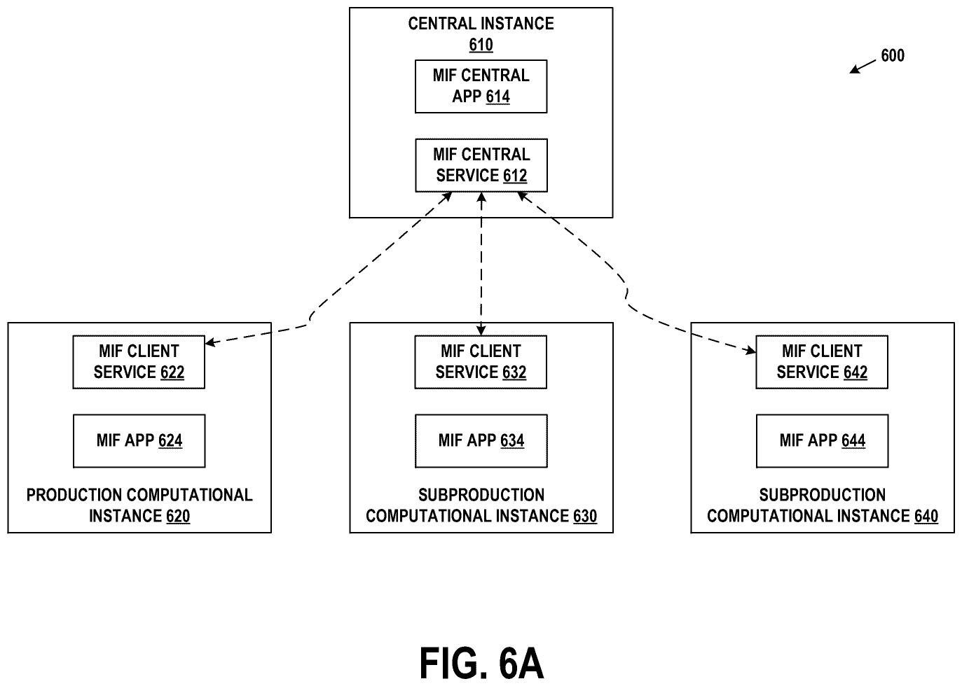

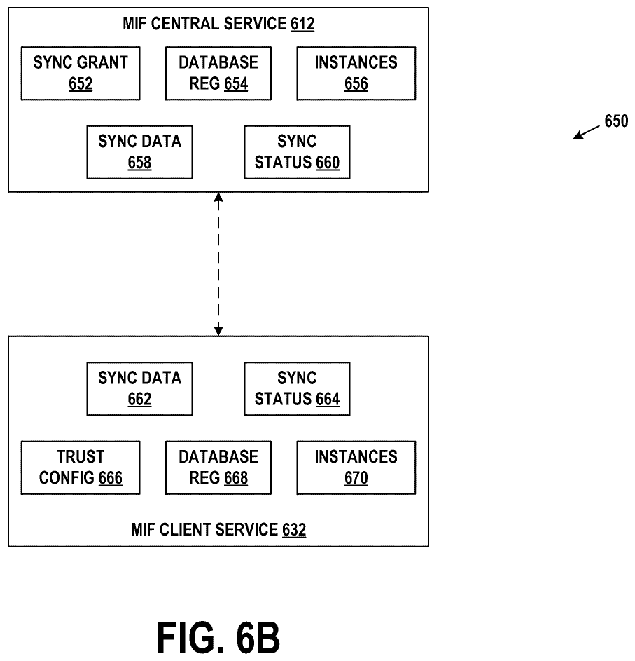

FIG. 6A depicts MIF 600 that facilitates enabling data synchronization and visibility across computational instances for a user, group or users, and/or one or more accounts that can be used to log into the computational instances. MIF can use a REST-based hub and spoke communication model for consistent point-to-point data synchronization between the computational instances. Nonetheless, other communication models could be used.

In FIG. 6A, central instance 610 includes MIF central service 612 and MIF central app 614. FIG. 6A also depicts production computational instance 620 (including MIF client service 622 and MIF app 624), subproduction computational instance 630 (including MIF client service 632 and MIF app 634), and subproduction computational instance 640 (including MIF client service 642 and MIF app 644).

Subproduction computational instances typically include various non-production environments used to develop, test, validate, and stage applications and changes to applications before deployment to a production computational instance. Development instances are utilized by software developers to build, customize, and configure applications, workflows, scripts, and integrations. Test computational instances provide environments to conduct functional, integration, regression, and performance testing, allowing teams to validate configurations and identify potential issues early in the lifecycle. Staging or pre-production computational instances closely mirror the production computational instance(s), enabling final validation, rehearsal of deployment procedures, performance testing, and verifying the readiness of changes prior to going live. Additionally, sandbox computational instances may be employed for experimentation or training purposes without impacting formal development cycles or production data.

MIF is composed of two scoped applications, MIF central service 612 and a MIF client service. The MIF client service is deployed upon each participating computational instance (shown in FIG. 6A as MIF client service 622, 632, and 642 for respective computational instances 620, 630, and 640). This architecture facilitates data flow between central instance 610 and computational instances 620, 630, and 640, as shown by the dashed lines in FIG. 6A.

Herein, the terms “MIF client service” and “MIF customer” are used interchangeably to refer to a scoped MIF application operating on a computational instance other than the central instance. Nonetheless, other terminology may be used to refer to the same component.

Applications integrating with the MIF framework (e.g., MIF apps 624, 634, and 644) determine what data to collect by registering database tables (or other forms of data repositories) with their respective MIF client services, MIF central service 612 and/or MIF central app 614. MIF then manages the trust between central instance 610 and computational instances 620, 630, and 640 for each unit of shared data, and performs the synchronization of the shared data. This communication between central instance 610 and any of computational instances 620, 630, and 640 may be initiated by a computational instance via scheduled jobs (e.g., hourly, daily, weekly) to maintain synchronization. To that end, the computational instance can use a REST client with mTLS and PKI authorization.

FIG. 6B depicts MIF central service 612 and MIF client service 632 in more detail. Here, MIF client service 632 is representative of MIF client services 622 and 642. As shown, MIF central service 612 includes sync grant 652, database registration 654, instances 656, synchronized data 658, and sync status 660. MIF client service 632 includes synchronized data 662, sync status 664, trust configuration 666, database registration 668, and instance 670. As discussed below, at least some of the components of MIF central service 612 and MIF client service 632 can be implemented as databases and/or database tables. But other possibilities exist.

MIF configuration between MIF central service 612 and MIF client service 632 can be managed by way of sync grant 652, trust configuration 666, instances 656, and instances 670. For example, trust within MIF may be based on the principle that a computational instance owns the ability to grant access to its data to another computational instance on an application-by-application basis and/or on a database-table-by-database-table basis. Thus, computational instance 630 may allow, by way of trust configuration 666, access for one or more other computational instances to one or more applications.

Sync grant 652 can store the sharing configuration for how computational instances (here, computational instance 630 and one or more other computational instances) share data. This information may be otherwise represented in trust configuration 666 as a mapping of applications from which data is shared to specific computational instances. Instances 656 may store the information about the computational instances with which MIF central service 612 is in communication and for which MIF central service manages or can manage shared data.

Applications on computational instance 630 and/or their database tables can be registered for synchronization via the database registration 668, which extends the sys_metadata table that can be found in most computational instances. The data contained in the sys_metadata table represents application configuration data. On central instance 610, database registration 654 can represent mappings between applications, names of their database tables on central instance 610, and names of the source database tables on computational instance 630. Instances 670 may store the information about the computational instances with which MIF central service 612 is in communication and for which MIF central service can manage shared data.

Synchronized data 662 represents the data to be shared from computational instance 630 to central instance 610. Synchronized data 658 represents the shared data as stored on central instance 610. In some implementations, synchronized data 658 may be stored in a schema-less arrangement (e.g., in a no-SQL database, JSON-like documents, and/or key-value pairs, or as serialized data in rows of database tables). Notably, synchronized data 658 may include synchronized data shared from other computational instances (e.g., computational instances 620 and 640) that may, in turn, be shared back to computational instance 630.

Sync status 664 represents the status of the synchronization of synchronized data 662 with central instance 610 from the perspective of computational instance 630 (e.g., not started, in progress, paused, completed, failed, etc.). Sync status 660 represents the status of the synchronization of synchronized data 658 computational instance 630 from the perspective of central instance 610 (e.g., not started, in progress, paused, completed, failed, etc.). These statuses may be separate for each database table shared by computational instance 630.

In one possible schema-less implementation for a given database table stored within computational instance 630, data from multiple rows of the original database table may be serialized into a structured format such as JSON or XML. This serialized representation is then stored as a single aggregated row within a database table hosted on central instance 610. Such an approach eliminates rigid schema constraints, enabling flexible storage and efficient retrieval of complex or nested data structures without modifying the database schema of central instance 610. For example, consider an original database table on computational instance 630 containing multiple rows representing user activities:

| ActivityID | UserID | ActivityType | Timestamp |
|---|---|---|---|
| 1001 | 501 | Login | 2023-03-20 08:45:00 |
| 1002 | 501 | Logout | 2023-03-20 09:15:00 |
| 1003 | 502 | Login | 2023-03-20 10:00:00 |

To implement a schema-less design for centralized storage, the computational instance 630 may serialize these multiple rows into a JSON document:

```
{
  “activities”: [
    {“ActivityID”: 1001, “UserID”: 501, “ActivityType”: “Login”, “Timestamp”: “2023-03-
20T08:45:00Z”},
    {“ActivityID”: 1002, “UserID”: 501, “ActivityType”: “Logout”, “Timestamp”: “2023-03-
20T09:15:00Z”},
    {“ActivityID”: 1003, “UserID”: 502, “ActivityType”: “Login”, “Timestamp”: “2023-03-
20T10:00:00Z”}
  ]
}
```

This JSON document can be stored as a single row in a database table (e.g., with or without whitespace) within central instance 610. Such an implementation allows flexible querying, updates, and storage efficiency, as changes to the original data structure do not necessitate modifications to the central database schema.

As noted above, using MIF is advantageous for users or groups of users that employ a number of computational instances. Particularly, it allows viewing resources represented in data repositories distributed across these computational instances from just one of the computational instances. For example, the MIF architecture allows users on one computational instance (e.g., computational instance 620) to be able to view and/or otherwise use data populated in databases on other computational instances (e.g., computational instances 630 and 640). This is helpful in cases when the user or group of users has access to a limited number of entitlements (e.g., software licenses) that can be distributed across the instances, as it avoids having to separately log into and view the entitlements configured on each computational instance. Other use cases exist.

The implementation of this data synchronization feature enhances computational efficiency by reducing resource usage across several areas, including processor utilization, memory consumption, network bandwidth, and power usage. The feature eliminates the need for users to manually log into multiple computational instances in a number of practical situations, thereby decreasing system overhead, reducing network authentication requests, and minimizing repeated resource-intensive login processes. Collectively, these improvements contribute directly to lowered power consumption. Ultimately, these efficiency gains lead to smoother, more scalable system performance and enhance sustainability.

A further advantage relates to the ability for MIF to automatically connect computational instances as they come online and to transmit data across computational instances with no user setup needed. Prior to MIF, any data transmission had to be manually configured between instances, and each module of data (e.g., a table) needed an individual integration. MIF introduces the notion that computational instances come online and can immediately begin participating in the flow of data (per the configured trust) without any point-to-point configuration required. MIF application developers define the kind of data they want to collect and encapsulate that into their applications which are installed on the computational instance. At run time, MIF facilitates the flow of that data (and all other applications atop MIF) across trusted computational instances with no user intervention required.

### A. Database Schema

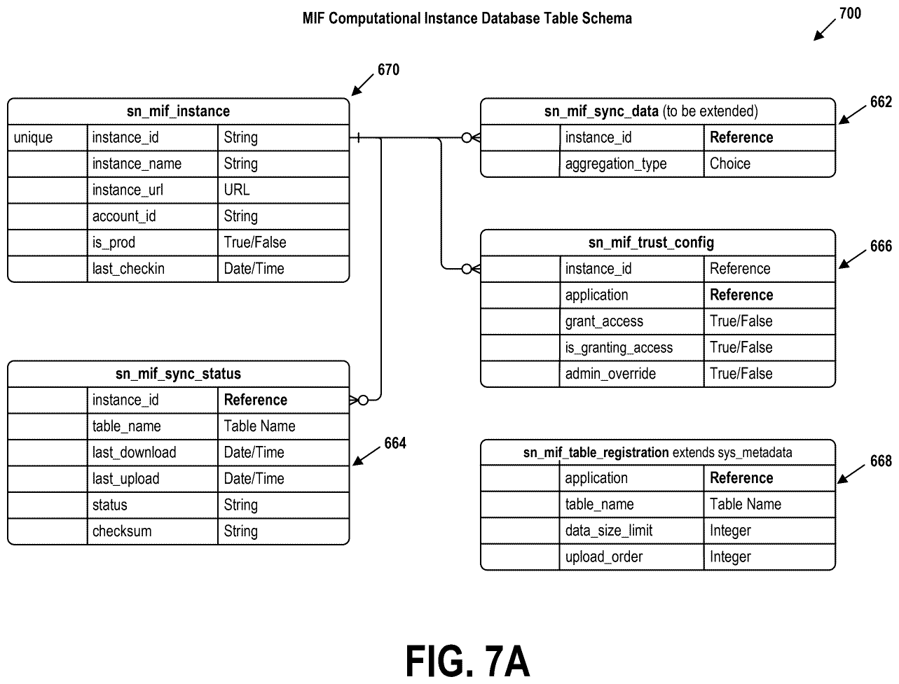

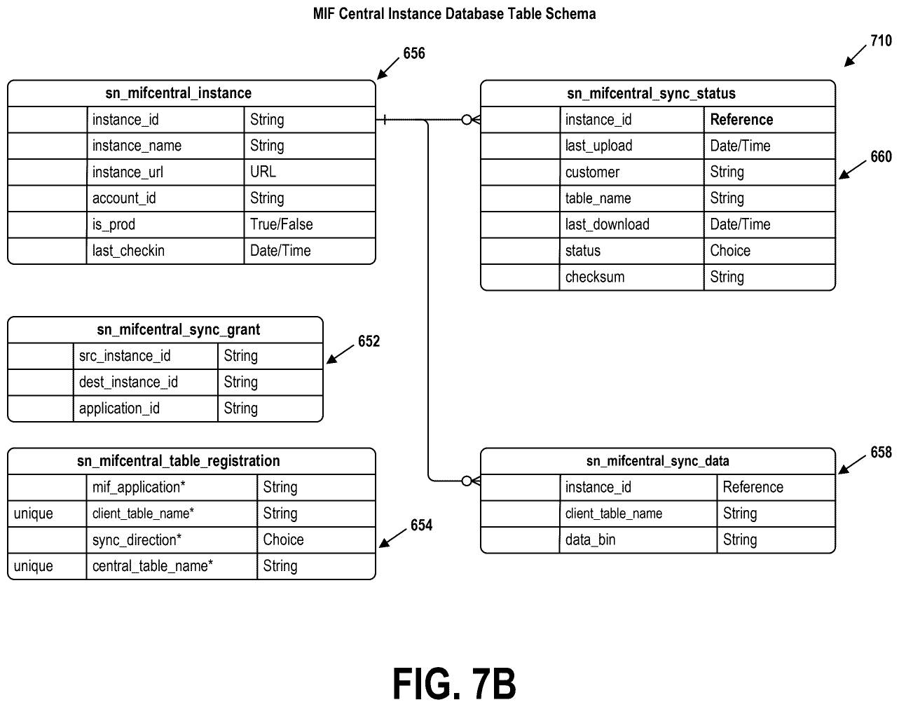

FIG. 7 depicts database schemas for computational instances and central instances. Schema 700 defines database tables for a computational instance, such as computational instance 630. Schema 710 defines database tables for a central instance, such as central instance 610. In line with the discussion above, the description below assumes that computational instance 630 is sharing data with other target computational instances by way of central instance 610.

Starting with schema 700, instances 670 (e.g., the sn_mif_instance table) at computational instance 630 stores metadata identifying each other target computational instance with which computational instance 630 shares data. Each entry contains an instance_id (a unique string identifier of a target computational instance), instance_name (a descriptive name of the target computational instance), instance_url (stores the URL of the target computational instance), account_id (links the target computational instance to its user account), is_prod (a Boolean flag indicating whether the target computational instance is a production environment), and last_checkin (captures the date and time the target computational instance last synchronized with central instance 610).

Sync status 664 (e.g., the sn_mif_sync_status table) at computational instance 630 maintains the status of synchronized data 662 for each other computational instance with which this data is shared. Fields include instance_id (a reference linking to the target computational instance to which the data is shared), table_name (specifying the database table on computational instance 630 involved in the synchronization process), timestamps last_download and last_upload (indicating when data was last synchronized in each direction between at least computational instance 630 and central instance 610), a status field (indicating the synchronization status), and a checksum string field (to verify the integrity and consistency of synchronized data).

Synchronized data 662 (e.g., the sn_mif_sync_data table) at computational instance 630 stores details related to data synchronized between computational instance 630 and the target computational instances by instance_id (a reference linking to the target computational instance to which the data is shared). It includes an aggregation_type field (indicating how data aggregation is handled during synchronization). This table may be extended to support schema-based or schema-less representations of the data.

Trust configuration 666 (e.g., the sn_mif_trust_config table) at computational instance 630 defines access configurations and permissions for specific applications relative to data synchronization between at least computational instance 630 and central instance 610. It references an instance_id (linking to the target computational instance to which the data is shared), and has an application reference (indicating the target application of which database tables or other repositories are shared). Boolean fields like grant_access, is_granting_access, and admin_override specify access-related permissions and overrides for administrators. For example, computational instance 630 may grant a target computational instance access to database tables of a specific application.

Database registration 668 (e.g., the sn_mif_table_registration table) at computational instance 630 registers database tables for synchronization between computational instance 630 and target computational instances. Fields include application (the name of the application that is sharing data via MIF), table_name (the name of a table that is related to the application and is sharing data via MIF), data_size_limit (the maximum size in bytes of this table—if the table exceeds this size, it may not be synchronized), and upload_order (numeric indication of an order in which tables are uploaded to central instance 610 for synchronization, e.g., lower numbers are uploaded first). Notably, there may be an overall cap (e.g., 1 megabyte, 2 megabytes, 5 megabytes) in the total amount of data synchronized per computational instance or per application, with upload_order used to prioritize some tables over others.

Turning to schema 710, instances 656 (e.g., the sn_mifcentral_instance table) at central instance 610 stores information identifying each computational instance with data shared to central instance 610 (e.g., computational instance 630 and the target computational instances). This table contains fields such as instance_id (a unique identifier of a computational instance), instance_name (a descriptive name of a computational instance), instance_url (a URL for accessing a computational instance), account_id (linking the computational instance to its user account), is_prod (Boolean indicating whether the computational instance is a production environment), and last_checkin (timestamp of last communication between a target computational instance and central instance 610).

Sync status 660 (e.g., the sn_mifcentral_sync_status table) at central instance 610 tracks synchronization status of synchronized data 658 between the target computational instance and central instance 610. Its fields include an instance_id (a unique identifier of a computational instance), timestamps last_upload and last_download (indicating when data was last synchronized in each direction), table_name (name of a table involved in synchronization), a status field (reflecting current synchronization status), and a checksum (for integrity verification).

Sync grant 652 (e.g., the sn_mifcentral_sync_grant table) at central instance 610 records permissions governing synchronization between central instance 610 and one or more target computational instances. It has fields src_instance_id (source computational instance, e.g., computational instance 630), dest_instance_id (destination computational instance, e.g., one of the target computational instances), and application_id (identifying the application for which data is being synchronized).

Database registration 654 (e.g., the sn_mifcentral_table_registration table) at central instance 610 stores synchronization registrations for data repositories such as database tables. It includes fields such as mif_application (identifier of an application associated with data to be synchronized), client_table_name (name of a database table storing data to be synchronzied), sync_direction (synchronization direction, either from a computational instance to central instance 610 or vice versa), and central_table_name (table name on central instance 610 storing the synchronized data).

Synchronized data 658 (e.g., the sn_mifcentral_sync_data table) records synchronization data payloads and related metadata. It references the instance_id (the computational instance that shared the data, client_table_name (identifying the source table from the computational instance that shared the data), and data_bin (containing serialized data from the source table).

The specific database tables and fields thereof described herein are presented for illustrative purposes. In alternative embodiments, different table names, data structures, relational configurations, or field types may be utilized to achieve the same or similar functionality as described. Additionally, various modifications, substitutions, or extensions may be made, including the use of alternative data storage models, logical schemas, or metadata representations suited to particular implementation environments.

### B. Synchronization Communication

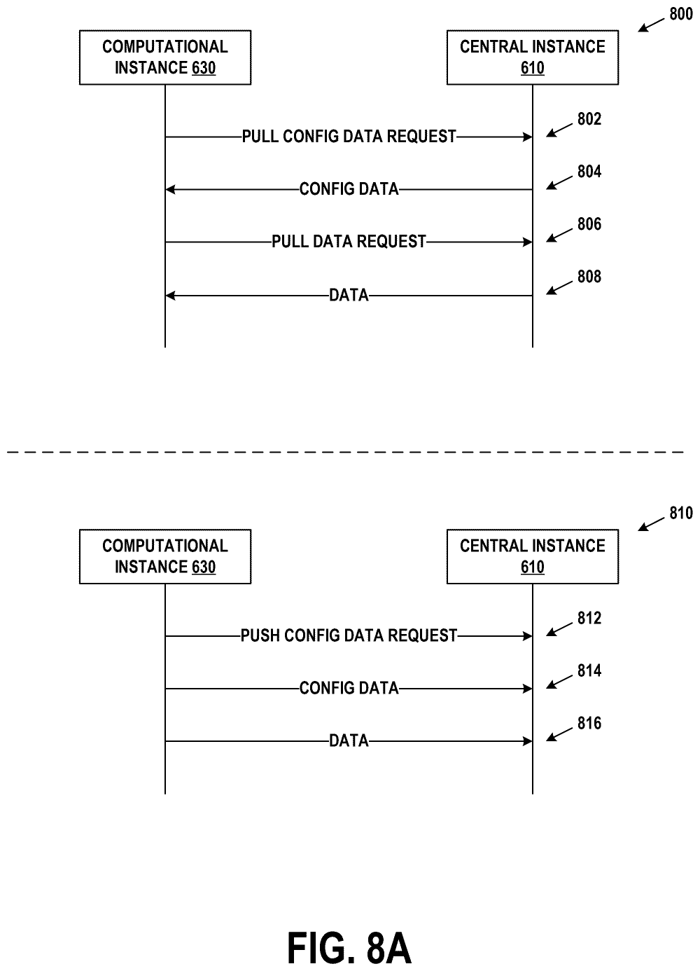

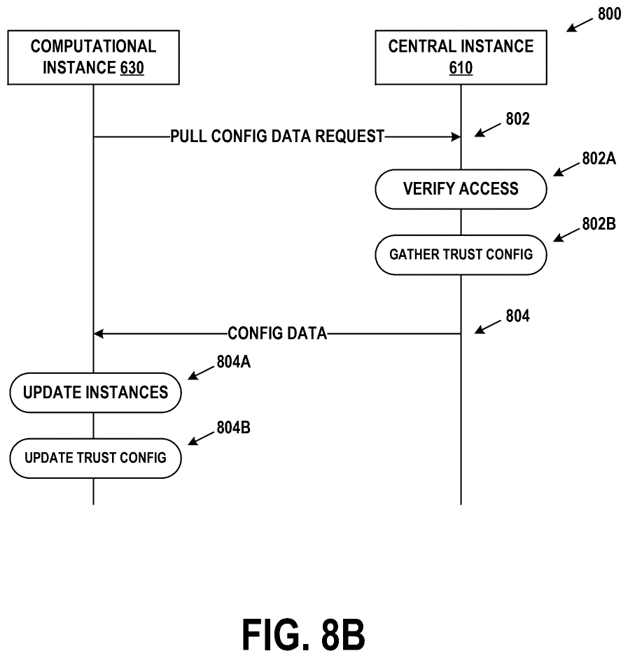

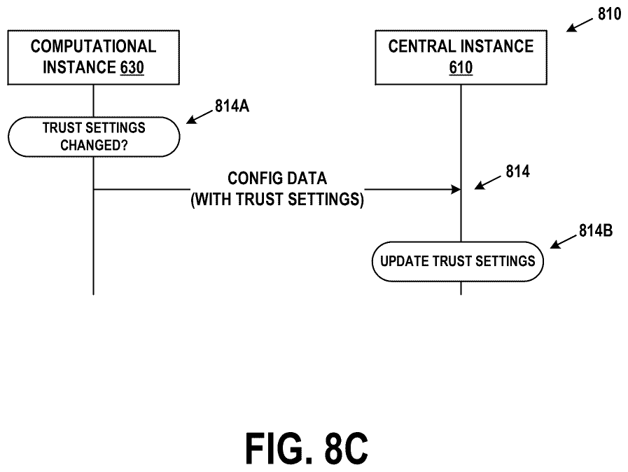

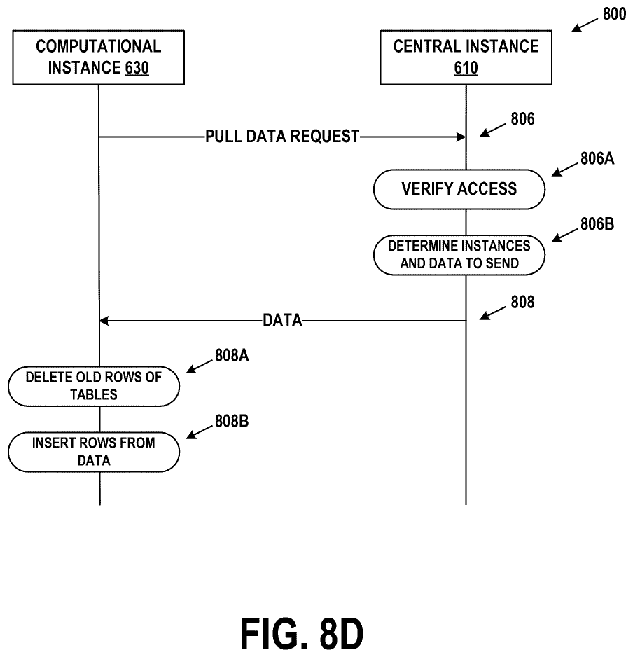

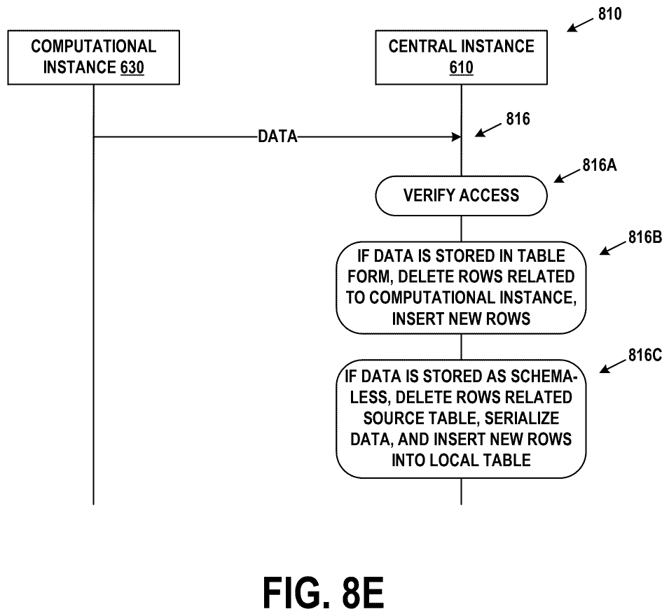

FIG. 8A depicts communication between computational instance 630 and central instance 610, for purposes of illustration. Nonetheless, communication between other computational instances and central instance 610 may take place. The communication may occur via REST APIs provided by central instance 610, initiated by MIF client service 632 on computational instance 630. Nonetheless, other communication frameworks and protocols can be used.

Synchronization may take place, for example, on 1-hour, 24-hour, or weekly cycle with two separate scheduled jobs. The REST APIs may be secured using the PKI service-to-service authentication and authorization framework as described below. These APIs can include: configuration pull (central instance 610 registers and validates computational instance 630, provides a list of other computational instances that have shared data with computational instance 630 and information related to scheduled synchronization jobs); configuration push (push a list of trusted computational instances to central instance 610 as targets for data shared by computational instance 630); data pull (central instance 610 provides shared data to computational instance 630); and data push (computational instance 630 transmits shared data to central instance 610).

MIF configuration and data synchronization operations can be managed via two scheduled jobs—a first job to pull configuration and data to computational instance 630 from central instance 610 and a second job to push configuration and data from computational instance 630 to central instance 610. These jobs can be individually activated and deactivated on either of computational instance 630 and central instance 610.

FIG. 8A depicts pull data transaction 800 and push data transaction 810. These transactions include pull configuration and push configuration steps, respectively. Here, pull data transaction 800 and push data transaction 810 are both initiated by computational instance 630, but similar transactions could be initiated by central instance 610. Also, computational instance 630 may employ MIF client service 632 and central instance 610 may employ MIF central service 612 to carry out some or all of these transactions.

In pull data transaction 800, step 802 may involve computational instance 630 transmitting a pull configuration data request to central instance 610. In response, central instance may reference one or more of sync grant 652, database registration 654, instances 656, and/or synchronization status 660 to determine configuration data to provide to computational instance 630. As noted, this configuration data may include information on application data stored in to central instance 610 that is shared to computational instance 630 from other computational instances. The configuration data may also include information in the trust configuration and the synchronization status relating to the sharing of application data between any one or more of these computational instances and/or central instance 610. Put another way, from the information in central instance 610, a list of computational instances visible to computational instance 630, their corresponding trust settings, and any relevant synchronization job schedule information may be determined.

Step 804 may involve central instance 610 transmitting configuration data to computational instance 630. Computational instance 630 may store any portion of this configuration data in the components of MIF client service 632. Optionally, and not shown in FIG. 8A, computational instance 630 may transmit some of its configuration data to central instance 610 so that central instance 610 can be updated with the most recent of this configuration data.

Step 806 may involve, perhaps based on the configuration data, computational instance 630 transmitting a pull data request to central instance 610. This pull data request may include indications of one or more sets of: (i) a target computational instance, (ii) one or more applications on the target computational instance, and/or (iii) one or more database repositories (e.g., tables) of these applications. Alternatively or additionally, central instance 610 may reference synchronized data 658 to determine the requested data (e.g., the requested data may be stored in synchronized data 658). Central instance 610 may also reference one or more of sync grant 652, database registration 654, instances 656, or synchronization status 660 to determine this data (e.g., to ensure that only data that is allowed to be shared with computational instance 630 is provided).

Step 808 may involve central instance 610 transmitting the data determined in step 806 to computational instance 630. In turn, computational instance 630 may store this data in synchronized data 662.

In push data transaction 810, step 812 may involve computational instance 630 transmitting a push configuration data request to central instance 610. For example, computational instance 630 may reference one or more of synchronization status 664, trust configuration 666, database registration 668, or instances 670 to determine and obtain the configuration data to provide to central instance 610. This configuration data may include a list other computational instances with which computational instance 630 is configured to share data, as well as lists of the data repositories (e.g., tables) within computational instance 630 that stores the data to be shared with each of the other computational instances, respectively.

At step 814, computational instance 630 may transmit this configuration data to central instance 610. Optionally, and not shown in FIG. 8A, central instance 610 may transmit some of its configuration data to computational instance 630 so that computational instance 630 can be updated with the most recent of configuration data relating to other computational instances.

Step 808 may involve computational instance 630 transmitting the data to be synchronized (e.g., that is stored in synchronized data 662) to central instance 610. In turn, computational instance 630 may store this data in synchronized data 658.

FIG. 8B depicts configuration pull communication in more detail. Particularly, after receiving a pull configuration data request at step 802, central instance 610 may, at step 802A, check sync grant 652 and/or database registration 654 to: (i) verify the access rights that computational instance 630 has with request to the configuration data on central instance 610, and/or (ii) determine the trust configuration between computational instance 630 and entries within synchronized data 658. Also, after receiving the configuration data at step 804, computational instance 630 may, at steps 804A and 804B, update instances 670 and trust configuration 666, respectively and as needed.

FIG. 8C depicts configuration push communication in more detail. Particularly, before transmitting configuration data to central instance 610 at step 814, computational instance 630 may, at step 814A, determine whether the trust settings in trust configuration 666 have changed since the last time configuration was synchronized between computational instance 630 and central instance 610. If this is the case (or of the trust settings have not yet been shared with central instance 610), the trust settings may be included with the configuration data transmitted at step 814. Also, after receiving this configuration data, central instance 610 may update the trust settings in sync grant 652 to at least reflect these changes.

FIG. 8D depicts data pull communication in more detail. Particularly, after receiving the pull data request at step 806, central instance 610 may, at step 806A, check sync grant 652 and/or database registration 654 to: (i) verify the access rights that computational instance 630 has with request to the requested data on central instance 610, and/or (ii) determine the sharing configuration between computational instance 630 and the requested data (e.g., data relating to which applications from which computational instances can be provided to computational instance 630). Here, the requested data may be a portion (e.g., a subset) of the totality of the data present on computational instance 610 that has been shared from other computational instances. After receiving the requested data, computational instance 630 may, at step 808A, delete rows of the database tables (e.g., represented by synchronized data 662) containing older versions of the requested data. Computational instance 630 may also, at step 808B, insert rows containing the requested data into these database tables. In some embodiments, the database tables may be updated in different ways.

FIG. 8E depicts data push communication in more detail. Particularly, after receiving the data at step 816, central instance 610 may, at step 816A, check sync grant 652 and/or database registration 654 to verify that computational instance 630 has permission to share the data by way of central instance 610. Assuming that this is case, the storage type for the data can then be determined. If the data is stored in database table form, one or more of the existing rows of a corresponding database table on central instance 610 may be deleted and new rows representing the data may be inserted. If the data is stored in a schema-less form, then one or more rows representing a serialized version of the data in a database table on central instance 610 may be deleted, the data serialized as discussed above, and the serialized data inserted into the database table as one or more new rows, also as discussed above.

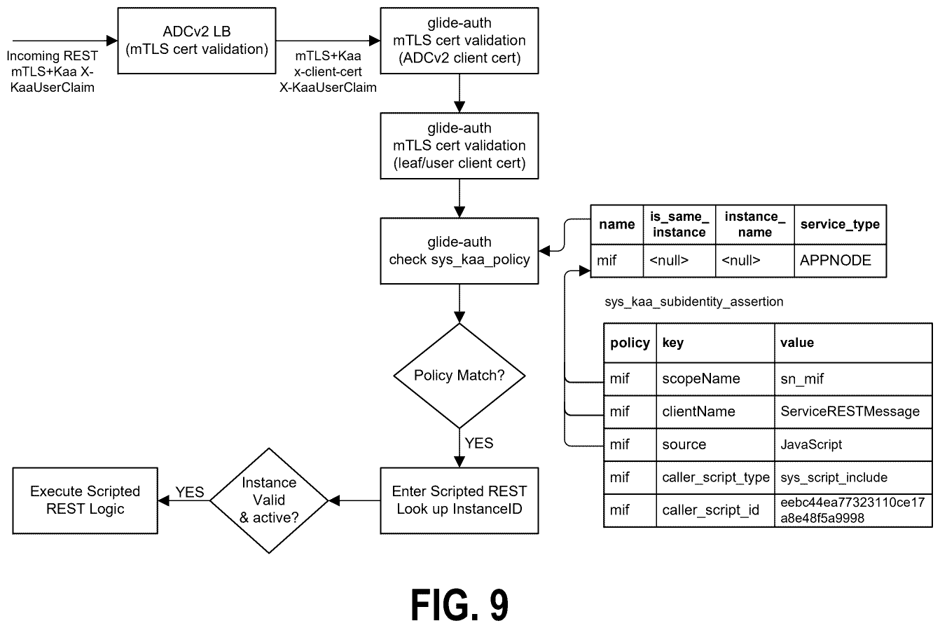

Communication between computational instance 630 and central instance 610 (e.g., MIF client service 632 and MIF central service 612) can be secured with PKI for authentication and authorization. Computational instance 630 can use a REST client which, in turn, uses the PKI identity keystore for computational instance 630 to establish HTTPs requests to central instance 610 via mTLS. Central instance 610 may validate HTTPs requests using the PKI certificate and sub-identity assertions. FIG. 9 depicts this security architecture handling an example request.

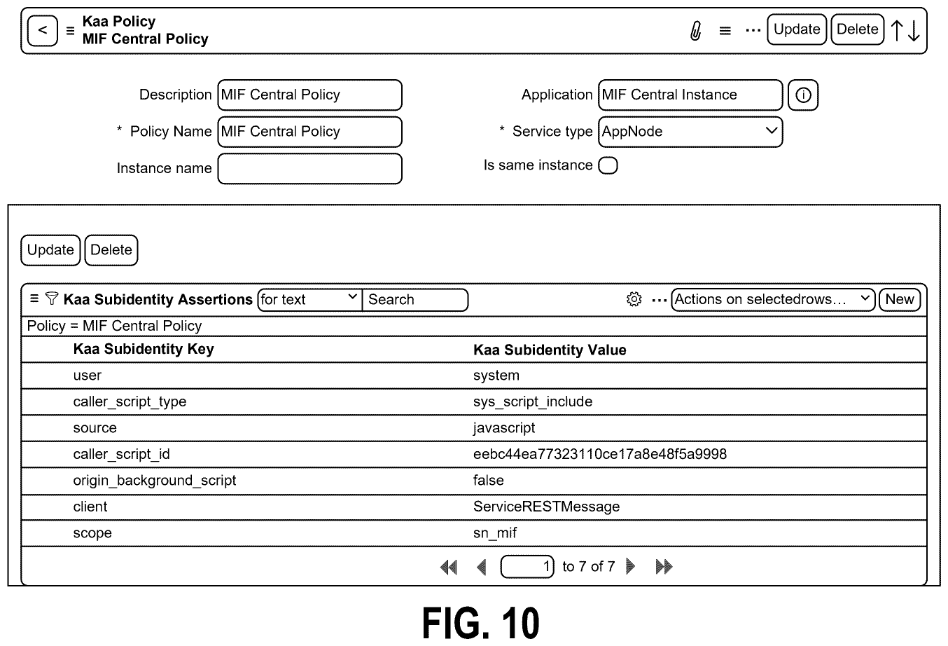

PKI sub-identity assertions enable assertions about the source of a request against several different aspects. FIG. 10 provides an example PKI policy. Central instance 610 may consider a request valid only if the request meets or matches all the assertions. If a request originated from a background script or by a different user, central instance 610 may treat this request as invalid.

### C. Configuration and Trust

A principle of trust within MIF is that a computational instance controls the trust configuration granting access to its data to another computational instance. By default, trust is granted from subproduction computational instances to their corresponding production computational instances.

An administrator can override this default and configure the trust on a computational instance as desired, on a per-application basis. Though the administrator can choose not to trust other computational instances with its data, it may not be possible to prevent that data being collected to the central instance for aggregation at the account level (see the aggregation section below).

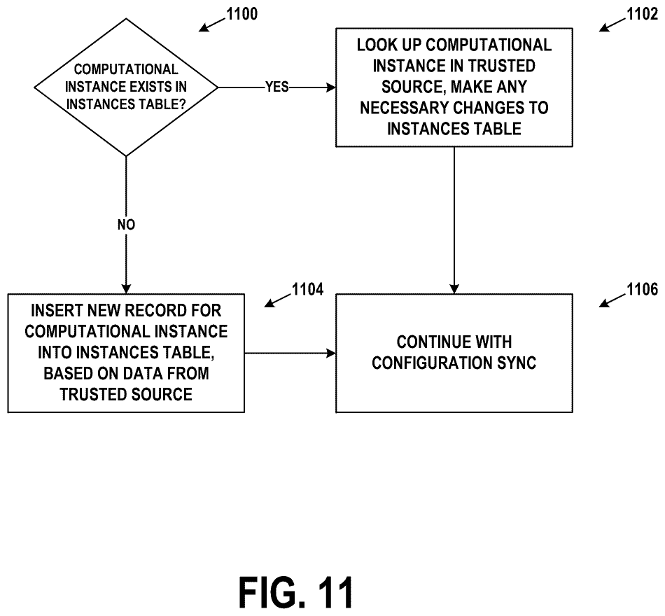

MIF tracks computational instances discovered by central instance 610 in instances 656 (e.g., the sn_mifcentral_instance table). FIG. 11 depicts the registration/discovery processes for computational instances.

Instances 656 can be populated from a trusted source or otherwise preconfigured. Specifically, the existing u_production_instances table at central instance 610 usually stores records for each computational instance per account, user, or organization. Each entry may detail aspects such as computational instance name, URL, associated user or users, versioning, computational instance state (e.g., active, inactive, maintenance), environment configuration details, associated licenses, or other metadata used to manage and track computational instances operationally.

At block 1100 of FIG. 11, when a computational instance first connects to MIF central service 612 by way of a request, MIF central service 612 looks up the instance identifier (e.g., instance_id of instances 656) of the computational instance in instances 656.

If the instance identifier exists in instances 656, then, at block 1102, MIF central service 612 looks up the instance identifier in the u_production_instances table. From the u_production_instances table, MIF central service 612 gathers account and other metadata such as whether the computational instance is a production or subproduction instance, and stores it in instances 656. If the computational instance is not found in the u_production_instances table, the computational instance does not have a proper record, or the computational instance has an empty account identifier, the request is rejected.

If the instance identifier is not found in the instances table, then, at block 1104, MIF central service 612 inserts a new record for the computational instance into instances 656 based on information from the u_production_instances table. Again, if the computational instance is not found in the u_production_instances table, the computational instance does not have a proper record, or the computational instance has an empty account identifier, the request is rejected.

At block 1106, MIF central service 612 continues with the configuration synchronization.

During the configuration push operation (e.g., as depicted in FIG. 8C), the list of other computational instances trusted by the computational instance are pushed to central instance 610 (e.g., step 814). These are stored in sync grant 652. Subproduction computational instances grant access to their corresponding production computational instances by default. No other trust is enabled by default, so production instance to production instance and subproduction instance to subproduction instance trust should be granted manually. Computational instances may also transmit, to central instance 610, a list of instance-application pairs, denoting access being granted to a particular computational instance for a particular application. In other words: between two computational instances, trust can be granted for each MIF-registered application separately and independently.

In the case that a computational instance is renamed and/or re-assigned to a new account, all existing trust records for the computational instance are removed by central instance 610, forcing trust to be re-determined and assigned on both sides (the computational instance which moved, and the computational instances remaining in the previous account).

### D. Data Synchronization

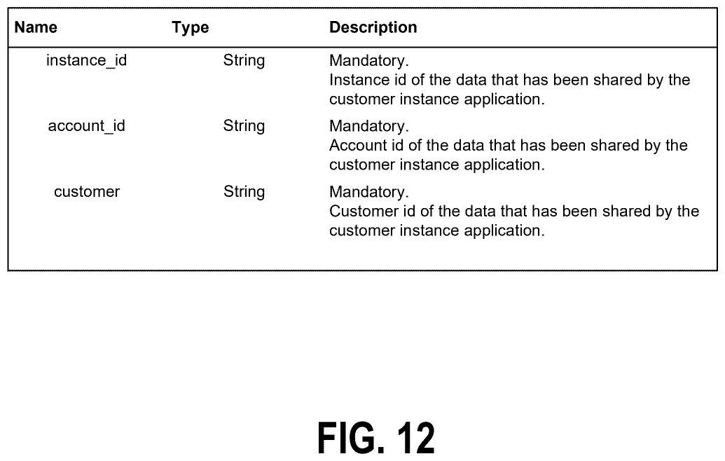

In some embodiments, MIF data synchronization happens only for registered application database tables. For data to be shared from one computational instance to another computational instance, applications can register their application database tables with MIF by creating a registration record in database registration 654 during application installation. If there is no central aggregation needed, only a registration record is required. Otherwise, the application (e.g., MIF central application 614) also creates a database table on central instance 610 corresponding to each registered computational instance database table and links them in the registration record (see FIG. 12).

MIF can have specific requirements that application database tables should adhere to for synchronization to occur. MIF may require fields of FIG. 12 to exist in the application's central instance database table(s). Database table(s) missing the mandatory fields may be ignored, and data synchronization for these tables may not occur.

A described above, two kinds of data storage are supported in MIF: schema-based and schema-less. For the schema-based approach, applications that use MIF can create their database tables in a central instance server. The MIF APIs then write the data from the database tables from the computational instance to the corresponding database tables in central instance 610. In case there is a mismatch between the columns present on an MIF-registered database table on central instance 610 versus a computational instance, MIF will make a best-effort attempt to match the data from the payload to the columns present on the receiving table. Any columns for which data was not sent, or missing columns (i.e., columns for which data was sent but that do not exist on the table), may be noted in sync status 660.

The second approach, schema-less, is where MIF does not require applications to create database tables in central instance 610. Instead, the data from their database tables in the computational instances are stored as a JSON or XML payload in sync data 658. This second approach has the benefit of less overhead of managing data tables on computational instances and central instance 610. One reason for the schema-based approach was for applications that need to write aggregation jobs on central instance 610. The aggregation jobs run on central instance 610 because it needs access to data of all computational instances in a given account.

### E. Aggregation

Herein, aggregation jobs relate to situations where MIF aggregates information from multiple computational instances in some fashion, rather than maintaining separate copies of this data per computational instance. For example, suppose that two related production computational instances are both counting the number of a particular type of transaction. The user may be interested in the sum of these counts rather than each individual number. An aggregation job can be used to add such aggregation information into the data stored at central instance 610 for these computational instances. Other operations than a sum (e.g., a product, average, media, etc.) may be used.

Aggregation jobs may be run against application data as needed. MIF can populate instance and account information in the application tables for the data received from computational instances. Application jobs can/should use these columns to run their aggregation logic and insert aggregate rows (entries) into a database table for MIF to share aggregation results with computational instances. Such an aggregate row is identified, e.g., in the example of sn_mifcentral_instance, where instance_id is null and the account_id field is populated. However, MIF supports aggregations at both the organization and account level.

For an aggregate row where only the account_id field is populated, the aggregation results can be shared with all the computational instances associated with the same account. For an aggregate row where organization and account information is populated, aggregation results can be shared with the computational instances that belong to the same organization. Applications may be responsible for populating the aggregate record based on how this data will be shared for their use case.

To facilitate spreading load for all accounts and computational instances across a 24-hour period while still sequencing to some extent within each account, MIF has an API which when given a start/end date time, will return a list of accounts to aggregate for that time. Their account values are hashed into a minute of the day. The result is stored the central instance 610, e.g., in a table of schedules.

### F. Data Protection

MIF uses a registration record in database registration 668 for each database table of an application that is to be synchronized between computational instances. As noted above, database registration 668 can take the form of the sn_mif_table_registration table. MIF also can be used to extend the synchronized data 662 (e.g., the sn_mif_sync_data table). When a row for a computational instance is inserted, the instance_id column can be populated.

In some embodiments, MIF is designed only for small scale, low cardinality data that does not grow over time. Each application integrating with MIF may be limited to, for example, 1 megabyte of data total (counting string data as 1 byte per character), distributed among all database tables registered for an application or a computational instance. Unless specifically called out with a maximum size in database registration 668, the data limit may be consumed in the order specified by “upload_order”. Once the limit is reached, the remaining database tables may not be synchronized. If a database table grows beyond the maximum allowed size, none of the excess data will be synchronized, and the status of the database table in sync status 664 may be set to either app_data_size_limit_exceeded or table_data_size_limit_exceeded depending on whether it was the application limit or a single database table limit that was reached.

Access to MIF database tables may be restricted to system administrators and any non-administrative users assigned the MIF administrator role. This is true of both the computational instance and central instance applications.

On the MIF computational instance application, system administrators (or a MIF administrator) may be able to modify trust configuration 666. As represented in the sn_mif_trust_config database table, these administrators can edit the grant_access field, which enables them to configure their computational instance's trust settings for each of the other MIF computational instances in their account. The other fields in this database table may be read-only, protected by field-level access control lists (ACLs). Every other MIF database table may be 100% read-only, even for system administrators. Thus, operations disallowed for any user are: create, write (except grant_access field on sn_mif_trust_config), and delete. Operations reserved for MIF system administrators are: read and report view.

On a central instance, a system administrator can perform any operations on MIF components. However, these components are protected from scripted access from non-MIF scripts. For the following components, there is only read access allowed for scripts outside MIF scope: sync status 660, sync grant 652, and instances 656. All other database tables, both on central instances and customer instances, may be configured only be accessed from scripts within the respective MIF scope.

MIF scripts that modify and read from MIF database tables, are set to “package_private” access, which means that only scripts from within the MIF scope can access them. MIF database tables are only modifiable from MIF-scoped scripts. The MIF application is private, which means an end-user administrator cannot switch into the scope or modify any application files.

Taken together, the above protections are such that when a request is made to one of the MIF central instance REST endpoints, it was not sent by a script written outside of the MIF scope. In conjunction with the PKI sub-identity assertions, this secures the data integrity of MIF application and configuration data, and prevents any unauthorized calls to central instance endpoints from being successful.

### G. Cloning

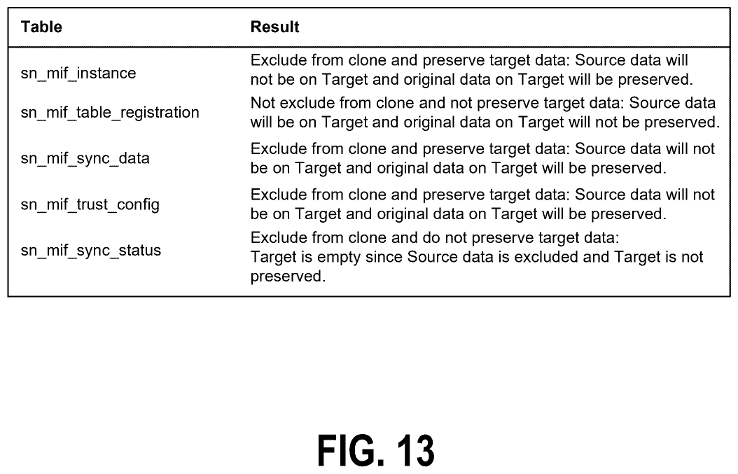

FIG. 13 depicts a cloning configuration for computational instances. Here, cloning refers to the process of creating a replica of a computational instance. This includes some or all of the data, configurations, applications, and customizations from the source instance being copied to a target instance. Thus, applications can have the clone configuration arranged for their database tables that are extending any MIF-related base table. With the configurations in place, a computational instance's application data may or may not be copied over to the target computational instance after the cloning operation. Also, the target instance of the clone process may or may not preserve its application data.

### H. Performance and Reliability

If a synchronization fails with, for example, 429 or 5XX HTTP return codes in response to a REST request, the MIF client application may retry the failing request with exponential back-off for a number of times (e.g., 2, 3, 5, or 8 retries). This is executed asynchronously by logging the request as a scheduled event in the event queue.

For the data push and configuration push APIs, a checksum is calculated based on existing data, and for every new job run, it is first detected whether the checksum has changed (i.e., new data has been added, or existing data has been modified or deleted). The data push and configuration push calls are made only if there is a change. A checksum is computed on the last updated date and number of rows for data synchronization, while it is computed on the configuration data intended to send to the central instance.

With database registration 654 as implemented by the sn_mifcentral_table_registration database table, the sync_direction (“up_only” or “both”) is verified for a shared database table in data pull and push operations. The corresponding database table name is obtained for the database table that is sent from the computational instance. For purposes of performance improvement, the sn_mifcentral_table_registration database table can be cached in main memory because it is frequently accessed, not changing often, and limited in size.

Conservative estimates for general request duration is as follows: configuration request—300 ms, data push—3 seconds, data push—10 seconds. Assuming 150,000 computational instances*4 requests (2 each of configuration+push+pull) is 600,000 per day, or about 7 requests per second. This translated to 17.5 concurrent requests for data pull, 5.25 concurrent requests for data push, and 1.05 concurrent requests for configuration. Thus, a reasonable multiprocessing configuration for these assumptions would be 16 threads per application node over two application nodes per central instance.

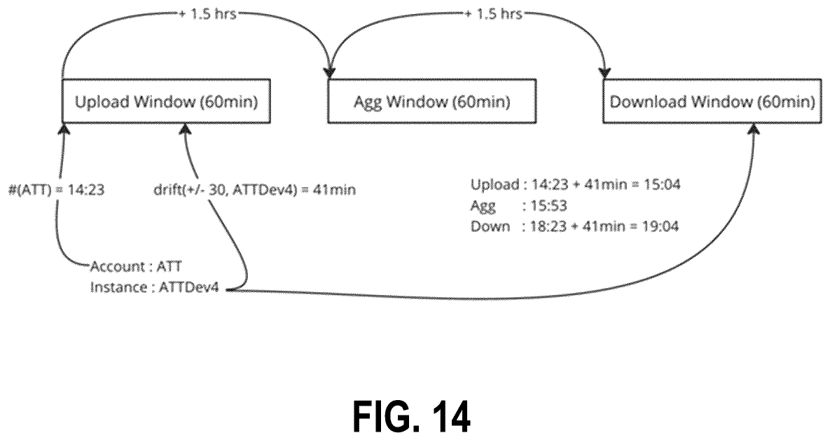

Since all computational instances can share a common central instance server, the synchronization jobs are evenly distributed across the day to spread the load in a 24-hour period. To achieve this, a hashing algorithm calculates a well-distributed time of the day for a given set of computational instances. This time is then used to run the synchronization jobs for those computational instances. An example design for the spreading algorithm: hash account ID mod 1440=>minute of day (for account); instance job(s)->60 minute drift (+/−30) from account time. Sequencing: Upload window 1 hour starting at account time 1) above; aggregation window starts from 1)+1.5 hours; download window starts from 1)+3 hours. FIG. 14 depicts the timing of these synchronization processes.

### I. Status Interface

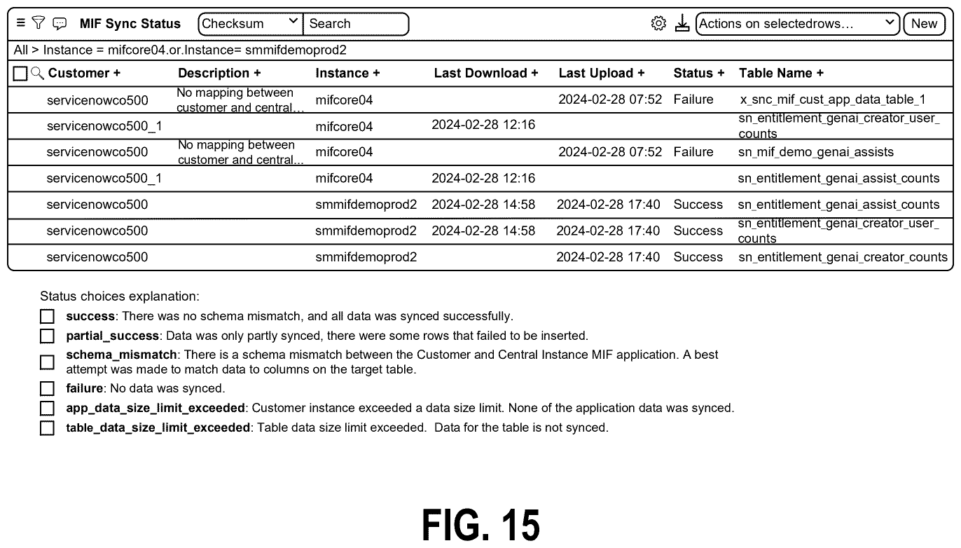

MIF provides status reporting by way of one or more graphical user interfaces. Particularly, MIF tracks instance and table-based synchronization status on both computational instance and central instance applications. FIG. 15 depicts an example user interface displaying synchronization status.

### VIII. EXAMPLE OPERATIONS

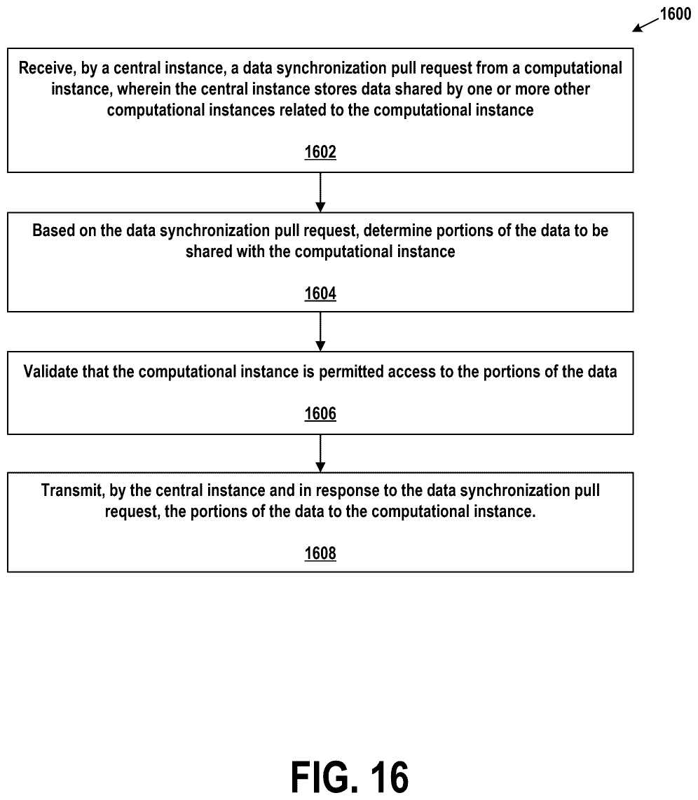

FIG. 16 is a flow chart 1600 illustrating an example embodiment. The process illustrated by FIG. 16 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 16 may be simplified by the removal of any one or more of the features shown therein. Further, these embodiments may be combined with features, aspects, and/or implementations of any of the previous figures or otherwise described herein.

Block 1602 may involve receiving, by a central instance, a data synchronization pull request from a computational instance, wherein the central instance stores data shared by one or more other computational instances related to the computational instance.

Block 1604 may involve, based on the data synchronization pull request, determining portions of the data to be shared with the computational instance.

Block 1606 may involve validating that the computational instance is permitted access to the portions of the data.

Block 1608 may involve transmitting, by the central instance and in response to the data synchronization pull request, the portions of the data to the computational instance. With these portions of the data at hand, the user of the computational instance no longer is required to log into the other computational instances to check their operation status or the status of various applications. Consequently, computing resources (e.g., processing, memory, network, and/or power capacity) are preserved.

In some embodiments, the computational instance is used as a production environment, wherein the one or more other computational instances are used as non-production environments.

In some embodiments, the portions of the data relate to an application, wherein a second computational instance of the one or more other computational instances is configured to share the portions of the data with the computational instance.

In some embodiments, the portions of data are stored in the second computational instance according to a database schema, wherein the central instance has replicated the portions of the data into a copy of the database schema stored on the central instance, and wherein transmitting the portions of the data to the computational instance comprises transmitting the portions of the data from the copy of the database schema.

In some embodiments, the data is stored in the second computational instance according to a database schema, wherein the central instance has replicated the data into a schema-less representation stored in a serialized manner on the central instance, and wherein transmitting the portions of the data to the computational instance comprises deserializing and transmitting the portions of the data from the schema-less representation.

In some embodiments, the schema-less representation is stored in the serialized manner within one row of a database table of the central instance.

Some embodiments may further involve, prior to receiving the data synchronization pull request: receiving, by the central instance, a configuration synchronization pull request; determining, based on the configuration synchronization pull request, that configuration data indicates that the portions of the data are shareable with the computational instance; and transmitting, by the central instance, a representation of the configuration data.

In some embodiments, the configuration data includes a list of the one or more other computational instances that have shared the portions of the data.

In some embodiments, the configuration data includes a list of one or more applications operable on the one or more other computational instances that are associated with the portions of the data.

Some embodiments may further involve: receiving, by the central instance, a data synchronization push request from the computational instance, wherein the data synchronization push request includes further data from the computational instance; and, based on the data synchronization push request, updating one or more database tables of the central instance to include the further data.

In some embodiments, the computational instance transmits the data synchronization pull request and the data synchronization push request according to different respective schedules.

In some embodiments, updating the one or more database tables of the central instance to include the further data comprises: determining that the further data is stored according to a database schema; and inserting, into a database table arranging based on the database schema, one or more rows containing the further data.

In some embodiments, updating the one or more database tables of the central instance to include the further data comprises: determining that the further data is stored in a schema-less representation; serializing the further data; and inserting, into a database table, a single row containing the further data as serialized.

Some embodiments may further involve generating, for display on a graphical user interface, a representation of, for each respective database table of a plurality of database tables storing respective portions of the data: (i) a name of which of the one or more computational instances from which the respective portions of the data were received, (ii) a timestamp of when the respective portions of the data were last downloaded to the computational instance, (iii) a synchronization status of the respective portions of the data, and (iv) a name of the respective database table.

In some embodiments, at least one value in the portions of the data is an aggregate value of values received from the one or more other computational instances.

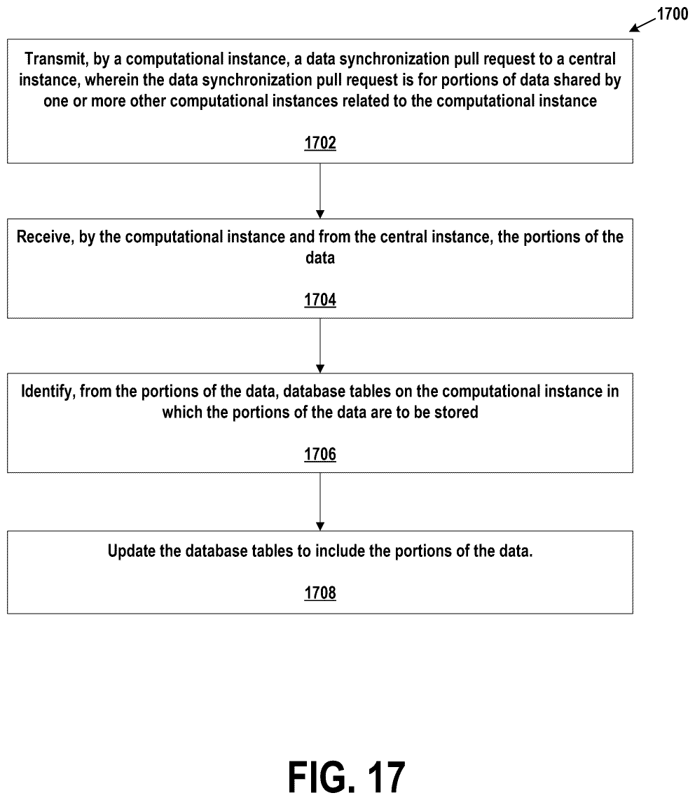

FIG. 17 is a flow chart 1700 illustrating an example embodiment. The process illustrated by FIG. 17 may be carried out by a computing device, such as computing device 100, and/or a cluster of computing devices, such as server cluster 200. However, the process can be carried out by other types of devices or device subsystems. For example, the process could be carried out by a computational instance of a remote network management platform or a portable computer, such as a laptop or a tablet device.

The embodiments of FIG. 17 may be simplified by the removal of any one or more of the features shown therein. Further, these embodiments may be combined with features, aspects, and/or implementations of any of the previous figures or otherwise described herein.

Block 1702 may involve transmitting, by a computational instance, a data synchronization pull request to a central instance, wherein the data synchronization pull request is for portions of data shared by one or more other computational instances related to the computational instance.

Block 1704 may involve receiving, by the computational instance and from the central instance, the portions of the data.

Block 1706 may involve identifying, from the portions of the data, database tables on the computational instance in which the portions of the data are to be stored; and updating the database tables to include the portions of the data. With these portions of the data at hand, the user of the computational instance no longer is required to log into the other computational instances to check their operation status or the status of various applications. Consequently, computing resources (e.g., processing, memory, network, and/or power capacity) are preserved.

In some embodiments, the portions of the data relate to an application, wherein a second computational instance of the one or more other computational instances is configured to share the portions of the data with the computational instance.

Some embodiments may further involve, prior to transmitting the data synchronization pull request: transmitting, by the computational instance, a configuration synchronization pull request to the central instance; and receiving, by the computational instance and from the central instance, configuration data that indicates that the portions of the data are shareable with the computational instance.

Some embodiments may further involve transmitting, by the computational instance, a data synchronization push request to the central instance, wherein the data synchronization push request includes further data from the computational instance, and wherein reception of the data synchronization push request causes the central instance to update one or more database tables of the central instance to include the further data.

### IX. CLOSING

The present disclosure is not to be limited in terms of the particular embodiments described in this application, which are intended as illustrations of various aspects. Many modifications and variations can be made without departing from its scope, as will be apparent to those skilled in the art. Functionally equivalent methods and apparatuses within the scope of the disclosure, in addition to those described herein, will be apparent to those skilled in the art from the foregoing descriptions. Such modifications and variations are intended to fall within the scope of the appended claims.

The above detailed description describes various features and operations of the disclosed systems, devices, and methods with reference to the accompanying figures. The example embodiments described herein and in the figures are not meant to be limiting. Other embodiments can be utilized, and other changes can be made, without departing from the scope of the subject matter presented herein. It will be readily understood that the aspects of the present disclosure, as generally described herein, and illustrated in the figures, can be arranged, substituted, combined, separated, and designed in a wide variety of different configurations.

With respect to any or all of the message flow diagrams, scenarios, and flow charts in the figures and as discussed herein, each step, block, and/or communication can represent a processing of information and/or a transmission of information in accordance with example embodiments. Alternative embodiments are included within the scope of these example embodiments. In these alternative embodiments, for example, operations described as steps, blocks, transmissions, communications, requests, responses, and/or messages can be executed out of order from that shown or discussed, including substantially concurrently or in reverse order, depending on the functionality involved. Further, more or fewer blocks and/or operations can be used with any of the message flow diagrams, scenarios, and flow charts discussed herein, and these message flow diagrams, scenarios, and flow charts can be combined with one another, in part or in whole.

A step or block that represents a processing of information can correspond to circuitry that can be configured to perform the specific logical functions of a herein-described method or technique. Alternatively or additionally, a step or block that represents a processing of information can correspond to a module, a segment, or a portion of program code (including related data). The program code can include one or more instructions executable by a processor for implementing specific logical operations or actions in the method or technique. The program code and/or related data can be stored on any type of non-transitory computer readable medium such as a storage device including RAM, ROM, a disk drive, a solid-state drive, or another tangible storage medium.

Moreover, a step or block that represents one or more information transmissions can correspond to information transmissions between software and/or hardware modules in the same physical device. However, other information transmissions can be between software modules and/or hardware modules in different physical devices.

The particular arrangements shown in the figures should not be viewed as limiting. It should be understood that other embodiments could include more or less of each element shown in a given figure. Further, some of the illustrated elements can be combined or omitted. Yet further, an example embodiment can include elements that are not illustrated in the figures.

While various aspects and embodiments have been disclosed herein, other aspects and embodiments will be apparent to those skilled in the art. The various aspects and embodiments disclosed herein are for purpose of illustration and are not intended to be limiting, with the true scope being indicated by the following claims.

What is claimed is:

1. A method comprising:
receiving, by a central instance, a data synchronization pull request from a computational instance, wherein the central instance stores data shared by one or more other computational instances related to the computational instance;
based on the data synchronization pull request, determining portions of the data to be shared with the computational instance;
validating that the computational instance is permitted access to the portions of the data; and
transmitting, by the central instance and in response to the data synchronization pull request, the portions of the data to the computational instance.

2. The method of claim 1, wherein the computational instance is used as a production environment, and wherein the one or more other computational instances are used as non-production environments.

3. The method of claim 1, wherein the portions of the data relate to an application, and wherein a second computational instance of the one or more other computational instances is configured to share the portions of the data with the computational instance.

4. The method of claim 3, wherein the portions of data are stored in the second computational instance according to a database schema, wherein the central instance has replicated the portions of the data into a copy of the database schema stored on the central instance, and wherein transmitting the portions of the data to the computational instance comprises transmitting the portions of the data from the copy of the database schema.

5. The method of claim 3, wherein the data is stored in the second computational instance according to a database schema, wherein the central instance has replicated the data into a schema-less representation stored in a serialized manner on the central instance, and wherein transmitting the portions of the data to the computational instance comprises deserializing and transmitting the portions of the data from the schema-less representation.

6. The method of claim 5, wherein the schema-less representation is stored in the serialized manner within one row of a database table of the central instance.

7. The method of claim 1, further comprising, prior to receiving the data synchronization pull request:
receiving, by the central instance, a configuration synchronization pull request;
determining, based on the configuration synchronization pull request, that configuration data indicates that the portions of the data are shareable with the computational instance; and
transmitting, by the central instance, a representation of the configuration data.

8. The method of claim 7, wherein the configuration data includes a list of the one or more other computational instances that have shared the portions of the data.

9. The method of claim 7, wherein the configuration data includes a list of one or more applications operable on the one or more other computational instances that are associated with the portions of the data.

10. The method of claim 1, further comprising:
receiving, by the central instance, a data synchronization push request from the computational instance, wherein the data synchronization push request includes further data from the computational instance; and
based on the data synchronization push request, updating one or more database tables of the central instance to include the further data.

11. The method of claim 10, wherein the computational instance transmits the data synchronization pull request and the data synchronization push request according to different respective schedules.

12. The method of claim 10, wherein updating the one or more database tables of the central instance to include the further data comprises:
determining that the further data is stored according to a database schema; and
inserting, into a database table arranging based on the database schema, one or more rows containing the further data.

13. The method of claim 10, wherein updating the one or more database tables of the central instance to include the further data comprises:
determining that the further data is stored in a schema-less representation;
serializing the further data; and
inserting, into a database table, a single row containing the further data as serialized.

14. The method of claim 1, further comprising:
generating, for display on a graphical user interface, a representation of, for each respective database table of a plurality of database tables storing respective portions of the data: (i) a name of which of the one or more computational instances from which the respective portions of the data were received, (ii) a timestamp of when the respective portions of the data were last downloaded to the computational instance, (iii) a synchronization status of the respective portions of the data, and (iv) a name of the respective database table.

15. The method of claim 1, wherein at least one value in the portions of the data is an aggregate value of values received from the one or more other computational instances.

16. A method comprising:
transmitting, by a computational instance, a data synchronization pull request to a central instance, wherein the data synchronization pull request is for portions of data shared by one or more other computational instances related to the computational instance;
receiving, by the computational instance and from the central instance, the portions of the data;
identifying, from the portions of the data, database tables on the computational instance in which the portions of the data are to be stored; and
updating the database tables to include the portions of the data.

17. The method of claim 16, wherein the portions of the data relate to an application, and wherein a second computational instance of the one or more other computational instances is configured to share the portions of the data with the computational instance.

18. The method of claim 16, further comprising, prior to transmitting the data synchronization pull request:
transmitting, by the computational instance, a configuration synchronization pull request to the central instance; and
receiving, by the computational instance and from the central instance, configuration data that indicates that the portions of the data are shareable with the computational instance.

19. The method of claim 16, further comprising:
transmitting, by the computational instance, a data synchronization push request to the central instance, wherein the data synchronization push request includes further data from the computational instance, and wherein reception of the data synchronization push request causes the central instance to update one or more database tables of the central instance to include the further data.

20. A non-transitory computer-readable medium, having stored thereon program instructions that, upon execution by a computing system, cause the computing system to perform operations comprising:
receiving, by a central instance, a data synchronization pull request from a computational instance, wherein the central instance stores data shared by one or more other computational instances related to the computational instance;
based on the data synchronization pull request, determining portions of the data to be shared with the computational instance;
validating that the computational instance is permitted access to the portions of the data; and
transmitting, by the central instance and in response to the data synchronization pull request, the portions of the data to the computational instance.
